(19) United States
(12) Patent Application Publication
(10) Pub. No.: US 2023/0230186 A1
(43) Pub. Date: Jul. 20, 2023

(54) SYSTEM AND METHOD FOR MATURABLE NON-FUNGIBLE TOKENS AND INTEROPERABLE IP TOKENS FOR A DECENTRALIZED INNOVATION PLATFORM

(71) Applicants: Erich Lawson Spangenberg, Paris (FR); Jonas Block, Dusseldorf (DE); Daniel Lawrence Bork, East Kingston, NH (US)

(72) Inventors: Erich Lawson Spangenberg, Paris (FR); Jonas Block, Dusseldorf (DE); Daniel Lawrence Bork, East Kingston, NH (US)

(21) Appl. No.: 18/070,244

(22) Filed: Nov. 28, 2022

Related U.S. Application Data
(60) Provisional application No. 63/283,700, filed on Nov. 29, 2021.
(60) Provisional application No. 63/285,235, filed on Dec. 2, 2021.
(60) Provisional application No. 63/266,862, filed on Jan. 17, 2022.
(60) Provisional application No. 63/300,722, filed on Jan. 19, 2022.
(60) Provisional application No. 63/306,954, filed on Feb. 4, 2022.

(51) Int. Cl. G06Q 50/18; G06F 16/23

(52) U.S. Cl. CPC G06Q 50/184; G06F 16/2379; G06Q 30/0206

(57) ABSTRACT

The invention relates to maturable non-fungible tokens and interoperable IP tokens transacted on an information, network, financing, commercialization and monetization platform that leverages the efficiency of artificial intelligence and decentralization to increase global innovation by individual, small and medium sized innovators and encourages global adoption by providing access to information, analytics, capital, resources, a trusted network and global partners. The invention relates to a method to establish a maturable non-fungible token recorded on a blockchain and referencing an extendable chain of custody, and to allocate intellectual property (“IP”) rights reliably, clearly, and in an interoperable manner to any non-fungible token recorded on a blockchain, independent of its origin of creation. Currently available NFTs are facing a range of technical and environmental challenges that need to be resolved in order to increase their tradability, enterprise adoption, future-proofness, and the legal certainty for parties transacting (with) NFTs.

### PRIORITY CLAIMS

This application claims the benefit of U.S. Provisional Patent Application Ser. No. 63/283,700, filed on Nov. 29, 2021; U.S. Provisional Patent Application Ser. No. 63/285,835, filed on Dec. 3, 2021; U.S. Provisional Patent Application Ser. No. 63/266,862, filed on Jan. 17, 2022; U.S. Provisional Patent Application Ser. No. 63/300,722, filed on Jan. 19, 2022; and U.S. Provisional Patent Application Ser. No. 63/306,954, filed on Feb. 4, 2022, all of which are incorporated herein by reference.

### BACKGROUND OF THE INVENTION

The invention relates to non-fungible tokens (NFTs).

### SUMMARY OF THE INVENTION

In general terms, the invention relates to a method to establish a maturable non-fungible token recorded on a blockchain and referencing an extendable chain of custody, and to allocate intellectual property (“IP”) rights reliably, clearly, and in an interoperable manner to any non-fungible token recorded on a blockchain, independent of its origin of creation.

Currently available NFTs are facing a range of technical and environmental challenges that need to be resolved in order to increase their tradability, enterprise adoption, future-proofness, and the legal certainty for parties transacting (with) NFTs.

One core area where disputes over NFTs are likely to arise, and actually do arise on a regular basis in practice already, is the proof of title or ownership, often referred to as proof of provenance.

As a rule of thumb, the following can be noted: Increasing immateriality of the tokenized asset coincides with an increasing likeliness of ownership-related disputes. If, for example, a physical asset like a painting on a canvas is tokenized, the possession of said asset in the physical world can indicate that the person in possession of said asset is likely the actual owner of the asset as the possessor has actual physical control over the asset. With regard to registered property, be it material property like real-estate registered in a public register/book, or immaterial property like intellectual property registered in a register maintained by a trademark and patent office, the register record serves as a pointer as to who is likely the current owner.

Both, physical possession and public registration, are by no means flawless and can neither make tokenization superfluous nor guarantee even an approximate degree of authenticity—as physical possession cannot prevent bad faith transactions by unentitled sellers, and register records actually depend largely on the maintenance and updating speed of the public register—but they at least can provide hints for ownership allocation.

A common use case for NFTs is, however, the tokenization of purely digital assets, and/or the digital representation of unique collectibles or memorabilia, where the value is built, sometimes even exclusively, on the authenticity of an asset. Tracking down the provenance of digital assets and alleged memorabilia used to be extremely difficult and posed a major challenge to any pre-sales due diligence process—which can easily result in high transaction costs threatening the economic viability of the transaction itself. There are two basic approaches to resolve or minimize ownership-related risks or authenticity-related risks:

In archival practice, proof of provenance is provided by the operation of control systems that document the history of records kept in archives, including details of amendments made to them. The authority of an archival document or set of documents of which the provenance is uncertain (because of gaps in the recorded chain of custody) will be considered to be severely compromised.

In the case that there is no or only incomplete proof of provenance, the history of ownership records can be sought to be tracked down on hindsight; a process commonly referred to as ownership verification. As such, ownership verification is effectively a risk mitigation operation with the aim of approximating asset ownership as closely as possible. In the space of collectibles, collectors commonly spend large amounts of extra time and resources to authenticate something because the proof of provenance is the only foundation upon which value can be built upon. Only after this is established can other factors such as rarity, condition, content, and demand be brought into the equation. But authenticators are human, they make mistakes or worse, have ulterior motives. As such, it is not entirely uncommon for art authenticators to make serious mistakes even at some of the largest auction houses.

As can be taken from the above, storing documentation related to ownership and maintaining a complete chain of custody throughout the lifetime of the corresponding asset to provide full proof of provenance, is the preferable approach for establishing the required certainty of the ownership allocation.

Blockchain technology has quickly established itself as a prevailing solution for the provision of proof of provenance. Services like WIPOproof, a service offered by the World Intellectual Property Organization, timestamp documents and thereby provide evidence for the fact that a specific digital document was in the possession of a specific private key holder at a given point in time. Other privately owned service providers were and are offering similar services.

The main drawback of such point solutions is that they do not provide a consistent and complete chain of custody as referenced above. Instead, as the term “point solution” already hints, these services provide dots without a connecting line subjected to a uniform standard of assessment. Accordingly, these solutions are merely providing additional indicators for ownership allocation but not proof of provenance for the digital asset as such. The drawback that these solutions are not bringing enough value to the table for players operating in the space is further evidenced not only by multiple enterprise failures in the space, but also by the fact that even a publicly funded service as WIPOproof is discontinued from Feb. 1, 2022.

An alternative to time-stamping digital assets or digital representations of physical assets is to mint them into a fully-fledged NFT very early in the manufacturing, maturity, or creation process to evidence the ownership using one of the common general NFT platforms like, e.g. OpenSea, or the corresponding functionality of cryptocurrency trading platforms like Binance and Coinbase.

The drawback of this second approach is that the NFT comes into existence once minted, a process that can trigger, even significant if applied at a large scale, minting fees to the service provider or gas costs to the blockchain miners. This is even more disadvantageous in an enterprise setting as many of the blockchains that are currently used for the creation of NFTs, like Ethereum, are still operating according to the proof-of-work method which is publicly criticized for its high computational expenses, electricity consumption, and the corresponding emission of millions of tons of carbon dioxide into the atmosphere—a no-go for modern companies with awareness of their ESG footprint.

Further, the token standards underlying the majority of the current NFTs like ERC-721 do not provide for the addition of documentation to an NFT after the conclusion of the initial minting process. In that case, the NFT is either minted too early in the asset evolution cycle—and potentially uninteresting for buyers—or multiple independently-tradable NFTs come into existence, adding to the ownership allocation conundrum that it originally intended to resolve.

A second core area where disputes in the context of NFTs arise on a regular basis is the allocation of Intellectual Property (IP) rights, especially regarding the assignment of IP commercialization rights and the scope of such assignment (if any).

Existing commercial NFT platforms are seen as stirring up IP-related uncertainty by potential customers and legal advisors, as the business model of such platforms essentially revolves around the act of minting a blockchain representation of an asset, be it a digitally native asset or a physical world asset, and provide little to no guidance and clarity around the question which IP rights of use the NFT owner can or cannot derive from the NFT ownership. The technology news portal TechCrunch summarized the overall situation in June 2021 as follows: “So far, no NFT platforms have ventured into internationally compliant territory for the copyright of art that an NFT sale represents. Doing so would be a tremendous leap for the NFT ecosystem.”

Recent examples for IP-related NFT disputes arising from this uncertainty are the court cases between movie studio Miramax and the director Tarantino over tokenized unpublished scenes of the movie “Pulp Fiction”, or between the collector Soleymani versus the renowned NFT artist Beeple.

Beyond the uncertainty regarding the transferred array of IP rights of use, decentralized environments, platforms and protocols in the Web 3.0 are going to provide significant challenges to effective IP right protection. Not in the sense that it would be more difficult to obtain IP rights but in the sense that decentralized use cases can result in collective infringement by many stakeholders acting together (intentionally or negligently) providing micro-contributions to the act of infringement, and/or in distributed infringement across a number of jurisdictions. What adds to the complication is the fact that each act of infringement will be of minor commercial relevance but the sheer mass of the number of infringements occurring can reach a quantitative dimension that affects the economic performance of creators and enterprises negatively. Copyright infringement by the reproduction of digital art and assets will increase in relevance as we are heading into the “Metaverse” as recently announced by Facebook's (now: Meta's) founder Mark Zuckerberg, where users will be represented by digital avatars in a virtual environment.

Overall, the aforementioned problems lead to the unsatisfying situation where the NFT functionality is reduced to mere ownership of a digital asset while it could be so much more. Any act of public utilization by its owner represents a potential risk of IP right infringement, which downgrades NFTs with IP relevance but without IP rights management integration effectively to mere collectibles that are stored away privately.

As of today, there are no effective solutions as to how to link IP rights to any NFT independent of the NFTs origin.

One prior art approach to connect an NFT with a copyright license is presented in a self-experiment undertaken and documented by Schoenherr.eu (https://www.schoenherr.eu/nft-self-experiment). It is expressed that “it is thus advisable—as NFT creator/author—to connect an NFT with a (copyright) license (clearly stipulating what rights are included in the NFT) and—as NFT purchaser—to check, whether the NFT (e.g. in a license) includes the rights that fit the specific needs for the intended use and exploitation of the NFT. For this experiment, we decided to connect our NFT to a non-exclusive license limited to a certain purpose.” How that “connection” is technically established in practice is not elaborated in any detail. The experiment mentions the step of minting the NFT before performing the step of linking the NFT to the copyright license using a smart contract.

The major drawback of this approach is that the copyright grant is a mere attribute of the NFT and depends on the status of the underlying smart contract, i.e. the grant of rights can be influenced by events and actions that are not necessarily verifiable in a blockchain-native environment (e.g. encryption of the metadata document) or even off-chain (e.g. default of the licensee on making the license payment and subsequent termination of the license grant by mere email). The proposed solution as such cannot provide the required legal certainty, especially not for third-parties that do not have insights into the rules engine/virtual machine executing the smart contract rules (e.g. EVM Opcodes for Ethereum) or into the metadata document. In other known solutions, IP rights are briefly mentioned in the seller's general terms of service that are published and maintained on a website that is not connected to the blockchain object in any way. One such example is the National Basketball Association's (NBA) Top Shot NFT offerings. Through a platform, the NBA allows users to buy, sell, and trade game highlights, called “Moments,” and such Moments are consistently being created from new game footage. But only the NBA's Terms of Service state that the buyer owns only the copy of the video, and nothing more.

The drawback of this solution is apparent: The Terms of Service are separate from the NFT on a Web 2.0 page, not persisted immutably on a blockchain and thus vulnerable to unauthorized manipulation, or one-sided amendment by the seller, or can simply be ignored by the buyer and/or third parties (wherein third-parties might not even be aware of the existence of the Terms of Service) without any repercussions or binding (contractual) consequence impacting the tradability of the NFT itself.

Against this background, it is the object of the invention to overcome the abovementioned and other drawbacks of the prior art and to provide a method to establish a maturable non-fungible token recorded on a blockchain and referencing a, and or relying on, an extendable chain of custody, wherein said chain of custody itself comprises at least one blockchain record, and wherein said chain of custody can be referenced by, or relied on by, one-to-many non-fungible tokens; and/or by adding hierarchical relationship information to NFT metadata documents; and a method to allocate intellectual property (“IP”) rights reliably, clearly, and in an interoperable manner to any non-fungible token recorded on a blockchain, independent of said non-fungible token's origin of creation. Further, corresponding systems, and corresponding rules engines are provided.

The term “blockchain” should be understood in this context to mean any application or protocol that is executed to regulate the process in which transactions between users are verified and recorded on a growing list of digital records (ledger) in a decentralized manner without relying on one central party and by leveraging the computational power of multiple network participants independent of the kind of the underlying consensus mechanism (e.g. proof-of-work, or proof-of-stake), or the respectively chosen governance model (e.g. permissioned, public, consortium, or the like).

The term “recorded” should be understood in this context to mean any kind of computer-aided or computer-effected writing to or storing on said distributed digital ledger and covers, but is not limited to, the processes of minting, tokenizing, and writing or updating of metadata points (independent of whether said metadata is encrypted or public), of non-fungible tokens.

The term “non-fungible token” (“NFT”) should be understood as a unique and non-interchangeable unit of data stored on a blockchain.

Global challenges abound, from health crises to climate change, overpopulation or famine. Innovation is the key to find solutions to these challenges, yet encouraging, identifying, protecting and promoting innovation has never been so complex, costly and misaligned with the needs and capabilities of those at the source of innovation: individuals and small and medium enterprises (SMEs). 9 in 10 businesses worldwide are SMEs, but less than 1 in 10 owns any type of Intellectual Property (IP). Because the global innovation system has been developed with western corporations' needs in mind, underpinned by outdated technologies resulting in complex and costly processes, small innovators are at a structural disadvantage, leaving a large part of the global innovation potential untapped.

Technological progress allows for a new reality. The combination of blockchain and artificial intelligence makes it possible to simplify how the world innovates today, limiting manual interventions, balancing information asymmetry and cutting time-consuming processes. These two technologies can materially decrease the transaction costs between all innovation stakeholders, realigning their interests and fostering the emergence of new innovation services, from analytics to funding and consulting opportunities. By decentralizing global innovation, Innovate.io proposes to unlock a blue ocean for innovation stakeholders anywhere in the world.

Innovate.io is a collaborative innovation platform that leverages ground-breaking technologies developed by the leader in IP and blockchain, IPwe, including non-fungible tokens (NFTs) tokenizing intellectual property and a global patent registry. With the new Innovate.io token and platform bringing together innovation actors such as patent attorneys, lawyers, technical experts, researchers, investors and more, small innovators anywhere in the world will have the ability to promote, evaluate, enhance, protect or share freely, develop, finance and commercialize innovative ideas globally, simply, safely, at a fraction of today's cost.

The system that underpins global innovation today to encourage, identify, protect and promote innovation, has spurred an unprecedented wave of innovation in the last century, best epitomized by the increasing, and self-reinforcing pace of disruptive innovations. But this system, designed and built in developed countries, allows large enterprises to create entry barriers in an era of globalization, and fuel increasing inequalities.

Innovation is already here, Gibson would say, but it's not evenly distributed: Five countries in the world account for over 90% of the world's patents and one thousand enterprises own half of all patents. Worse, 9 in 10 businesses worldwide are small and medium enterprises (SMEs), but less than 1 in 10 owns any type of Intellectual Property (IP). Innovation occurs on a local level—let there be no doubt that large enterprises innovate nothing—individuals and small teams of individuals innovate. Today, individual and small innovators are at a structural disadvantage, and many are discouraged from pursuing their ideas, leaving a large part of the global innovation potential untapped. Why is that?

Complex processes. The global innovation system still depends on complex laws understood by a select few, manual reviews and traditional information systems resulting in exclusive and time-consuming processes. Small innovators suffer from information asymmetry and lack the time to navigate such complex processes.

High costs. The transaction costs to create, refine, develop, protect and commercialize innovation are staggering, and driven up by centralization. Capital allocation largely ignores most of the developing world, further driving these costs up and further fueling inequalities in the innovation ecosystem.

Misaligned incentives. Great ideas that lead to improvement in the human condition are not the exclusive provenance of large corporations based in a handful of countries. Yet centralized innovation systems that prevail today benefit the latter. Intangibles such as R&D expenditure or goodwill for instance, are often listed on the balance sheets of enterprises but much less so by SMEs who are more concerned with growth than moats. Innovation arises bottom-up through the ingenious efforts of individuals and small teams, but today's innovation systems are designed top-down by regulators and lobbyists and guided by large enterprises. As a result, these innovations create more value for corporate shareholders than for those creators at the source of innovation. Individual and small innovators are ignored or left to struggle in a system that is just not aligned with their resources and capabilities.

The global system underpinning innovation should reflect the decentralized nature of innovation. This was not possible until very recently, and it is thanks to technological progress led both by large enterprises and individual innovators such as Satoshi Nakamoto, that it is possible today to break open an entirely new innovation market.

Combining two of the leading technologies of the 4th Industrial Revolution, blockchain and artificial intelligence, it is possible to drastically reduce the costs and complexity historically associated with innovation. A marketplace leveraging these technologies to provide innovation stakeholders access to information, protection, capital, and a trusted network of global partners can make it possible for millions of innovators to enter the global innovation market. The socio-economic benefits are immense. For instance, a startup's first patent application approval can lead to an increase in growth of employment by 36% and an increase in sales by 51% on average for the next five years¹. ¹ Farre-Mensa, J. and Hegde, D. and Ljungqvist, A. (2016) The Bright Side of Patents. NBER Working Paper No. w21959, Available at SSRN: https://ssrn.com/abstract=2729060

Going further, the cross-fertilization of ideas at all stages of the innovation process, made possible in such a marketplace, will significantly increase the social efficiency² of today's global innovation system, and reduce the constraints of geographical proximity. Indeed, from the very early stage of ideation, innovators have to face the trust dilemma of sharing their ideas and losing intellectual property. Blockchain, in particular non-fungible tokens (NFTs), makes it simple and cost-efficient enough for innovators to share their ideas without losing intellectual property, allowing them to refine and improve their innovation safely with others, independently of their location. ² Von Hippel, E. (2005) Democratizing Innovation. The MIT Press.

Recent advances in artificial intelligence also provide for an effective solution to compare and evaluate innovative ideas against existing ones rapidly, limiting manual interventions, balancing information asymmetry, cutting time-consuming processes while exponentially impacting the inclusivity of today's global innovation system. Innovate.io strongly believes that innovation is not the exclusive provenance of a thousand of the world's largest corporations and that innovation is global. Individual and small innovators in any area of the world are capable of identifying a need or improvement that can be solved through innovation.

Last but not least, the tokenomics of the blockchain economy provides for reliable, scalable and secure options to foster network effects between all innovation stakeholders in ways that were just not possible until today. This assuredly will unlock global value creation while measurably expanding global innovation and improving the human condition.

Innovate.io is a decentralized marketplace to advance global innovation. It provides innovation stakeholders anywhere access to information, analytics, capital, resources and a trusted network of global partners to safely develop, protect and commercialize innovative ideas.

Innovate.io allows Innovators to empirically evaluate their ideas using artificial intelligence and then to improve ideas iteratively all whilst protecting intellectual property. Those innovations that are scored above a threshold level are rewarded with $innovate tokens. These innovations represent what are likely to be the most promising innovations that then can be protected, financed, further developed and commercialized using the Innovate.io platform.

Using the Innovate platform will allow all innovators to maximize the value of their ideas, individually or collectively, using an ever-developing array of decentralized productization services. The innovator chooses whether and where to protect their innovation and whether, when and under which terms to make it available for public or private use.

Four types of stakeholders interact within the Innovate.io marketplace: Innovators are individuals or a group of individuals who contribute to the platform with innovative ideas and seek services, financing or expertise from other platform stakeholders to bring these ideas to life. Service Providers are lawyers, patent attorneys, technical experts, research institutions, patent offices, brokers, law firms, government bodies or any other type of person/entity providing services regarding the establishment, development, and refinement of innovation. Partners are financial organizations and individuals that can fund Innovators, enterprises interested in commercializing Innovators' ideas or universities seeking to further their research. Investors are individuals and entities who are seeking earlier stage opportunities where outsized social and financial returns typically reside. The Innovate.io Association, a Swiss nonprofit organization, oversees the launch and decentralization of the Innovate.io platform and $innovate token.

The Innovate.io Association is a nonprofit based in Switzerland, that oversees the launch and decentralization of the Innovate.io platform. Innovate.io is the result of decades of combined experience from global leaders in the Intellectual Property and Technology sectors, now working together at IPwe, building the world's first Global Patent Market. Operating in more than 50 countries around the world with offices in Asia, Europe, and North and South America, IPwe has been building the tech stack on both the AI and blockchain side that will underpin the Innovate.io platform. IPwe will continue to pursue its mission with enterprise innovators, in view of becoming the reference fintech platform for IP as a new asset class, while Innovate.io will serve individual and SMEs innovators.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 shows a prior art ERC-721 metadata document, both in JSON format and schematically.

FIG. 2A schematically shows a metadata document with Asset Array and Asset Documentation Array.

FIG. 2B schematically shows the metadata document according to FIG. 2A with a linked container to the Asset Documentation Array.

FIG. 3A schematically shows a metadata document with sub-arrays in the Asset Documentation Array.

FIG. 3B schematically shows the metadata document according to FIG. 3A with a linked container to a sub-array of the Asset Documentation Array.

FIG. 4A schematically shows the metadata document according to FIG. 2B, referenced by two NFTs.

FIG. 4B schematically shows the metadata document according to FIG. 3B, referenced by two NFTs.

FIG. 5 schematically shows a (ex ante) maturing process.

FIG. 6 schematically shows how two NFTs can be linked hierarchically (ex post).

FIG. 7 schematically shows how interoperable IP Tokens can be connected to a title NFT independent of the title NFTs origin.

FIG. 8A schematically shows the structure of an IP Control Token.

FIG. 8B schematically shows the structure of an IP Token tied directly to a title NF.

FIG. 8C schematically shows the structure of an IP Token that is derived from an IP Control Token.

FIGS. 9A-B provide an overview of the platform of the present invention.

FIG. 10 is an illustration depicting an exemplary operating environment including one or more user computers, computing devices, or processing devices, which can be used to operate a client, such as a dedicated application, web browser is shown.

FIG. 11 is another illustration depicting an exemplary operating environment including a computer system with various elements as shown.

FIG. 12 is a diagram depicting the platform's web service infrastructure.

FIG. 13 is a depiction of the platform's web services, as well as the components of an exemplary operating environment in which embodiments of the present invention may be implemented.

FIG. 14 is an illustration of a multi-server room and the various locations in which other pertinent server rooms may exist.

FIG. 15 is a diagram outlining the web services incorporated with server-client communication.

FIG. 16 is a diagram of the flow of access between the platform of the present invention and the web services client via cloud software tools.

FIG. 17 is a diagram of an example of the cloud storage organization in which the web services accesses and retrieves user data as objects in buckets within a cloud storage space.

FIG. 18 is a line diagram illustrating a decentralized network.

FIG. 19 is a line diagram illustrating a distributed network.

FIGS. 20A-D are flow diagrams of the process of the present invention.

FIGS. 21A-C are flow diagrams of the process of the present invention.

FIG. 22 is a diagram of the token uses for each stakeholder of the present invention.

FIG. 23 is a flow diagram showing the NFT interaction with smart contracts of the present invention.

FIG. 24 is a flow diagram of the tokenomics design of the present invention.

FIGS. 25A-B are images of token distribution and sale details of the present invention.

### DETAILED DESCRIPTION OF THE PREFERRED EMBODIMENT

As mentioned above, the main drawback of existing blockchain-based solutions to capture the provenance of an asset is that they do not provide a consistent and complete chain of custody as these known solutions either rely on selective time-stamping, or on the costly creation on multiple independent NFTs.

These existing drawbacks relating to ownership/title and the capture of a chain of custody using blockchain technology can be overcome technically by a maturable non-fungible token recorded on a blockchain providing a carefully dosed amount of flexibility in terms of the substantive scope of the NFT.

Generally, an NFT comprises the data of (1) the owning account, (2) a hash of the metadata, and (3) a pointer to the metadata document. The metadata document is the core of an NFT as it contains all datapoints relating to the NFT, often comprising but not limited to the following datapoints: NFT's name; description of the NFT; link to a digital document (e.g., a hosted image, video, 3D animation or the likes); and other NFT Attributes.

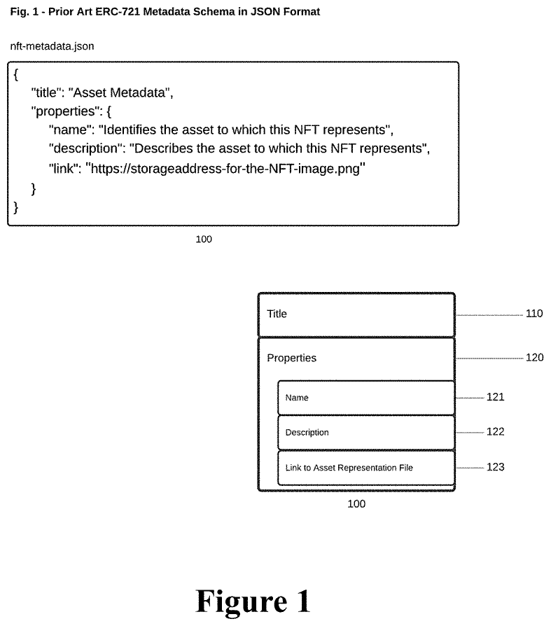

As such, the file type of the metadata document can be chosen from a range of file types. Commonly, the JSON format is used but other formats, even graphic formats like SVG, are eligible as well. The basic infrastructure of an NFT metadata document as is commonly used in the prior art is illustrated in FIG. 1. The metadata document 100 is typically not stored as an extension of an (e.g. an ERC-721) NFT itself directly on-chain as the costs are simply too high. Instead, the metadata document 100 is stored as a separate file, in FIG. 1 with the filename “nft-metadata.json”, in an online file storage solution like the InterPlanetary File System (IPFS) or the like. The NFT then contains a pointer to the storage location of the metadata document 100.

In FIG. 1, the individual datapoints of the prior art metadata document are shown both in the JSON format and as a schematic breakdown. The document shown in this example contains the objects “title” 110, and “properties” 120. The properties 120 are sub-divided into the string values “name” 121, “description” 122, and “link” (to a file representing the asset) 123. The link 123 is the most important datapoint as it identifies the location of the digital representation of the tokenized unique asset, in the example an image in the .png format.

The following explanations will refer generally to “arrays” but it is well understood, that any other suitable documentation format, even within the JSON format (e.g. objects, string values, etc.), is addressed as long as it is possible to differentiate which documentation identifies the unique tokenized asset itself and which documentation is simply supporting documentation describing the unique tokenized asset or specific attributes of the unique tokenized asset. The arrays can also be split up into separate documents and/or replaced by pointers to other documentation as will be addressed below.

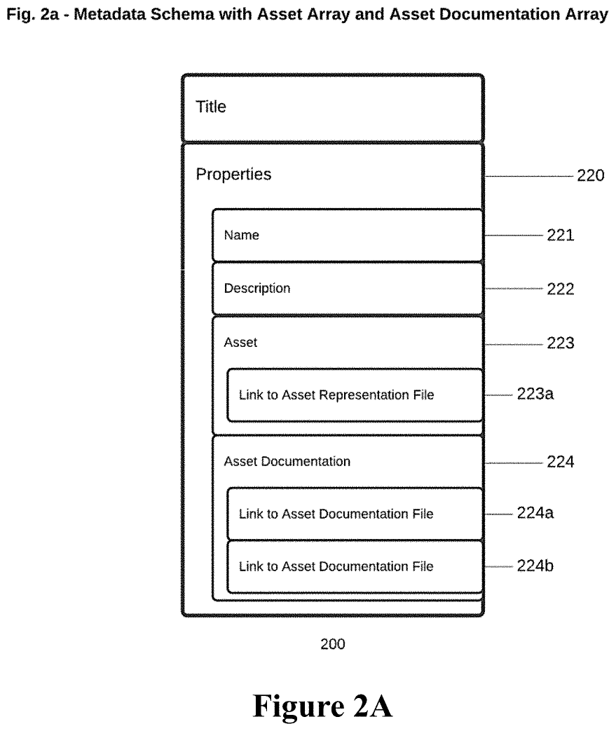

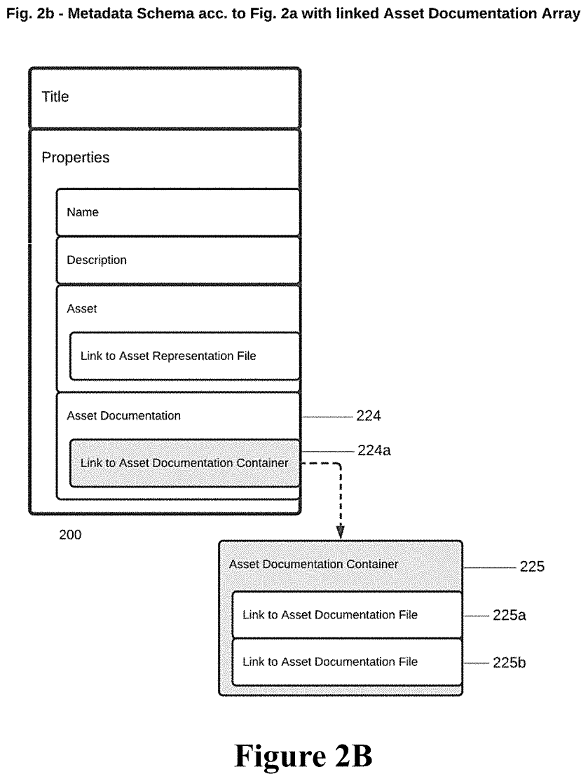

To start off with, maturable NFTs are designed in a way that differentiates technically between what is considered being the asset and what is considered being mere asset documentation. This can be achieved according to a preferable approach, by splitting the metadata document into an “Asset Array” and an “Asset Documentation Array” as is depicted by way of example in FIGS. 2A and 2B. According to the approach outlined in FIG. 2A, the Properties array 220 of the metadata document 200 comprises the fields Name 221, and Description 222, and two arrays—the Asset Array 223, and the Asset Documentation Array 224. The Asset Array 223 contains the pointer(s) to the digital document(s) identifying the tokenized unique asset itself (e.g. one or more pictures of the asset, a textual description, unique identifiers for stored documents (like on IPFS or using FileCoin), a QR code, a video file, a combination of the aforementioned, and/or asset references as will be elaborated below with regard to the Asset Reference Array), while the Asset Documentation Array 224 contains the additional pointer(s) to digital documentation about the asset (herein also referred to as “contextual information”, e.g. ownership-related documents (also referred to as chain of custody documentation) or value-related documents). In FIG. 2A, the Asset Array 223 contains one such pointer 223A to an Asset Representation File, while the Asset Documentation Array 224 contains two such pointers 224A and 224B to two Asset Documentation Files.

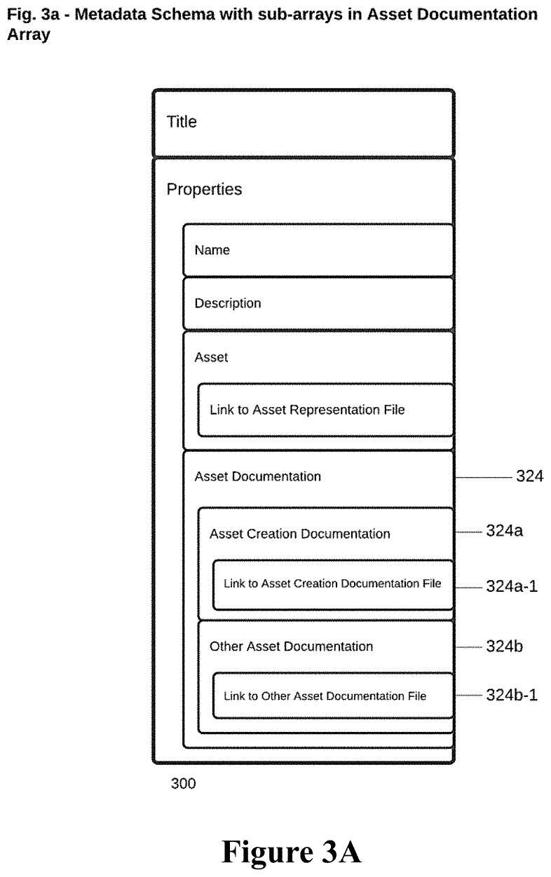

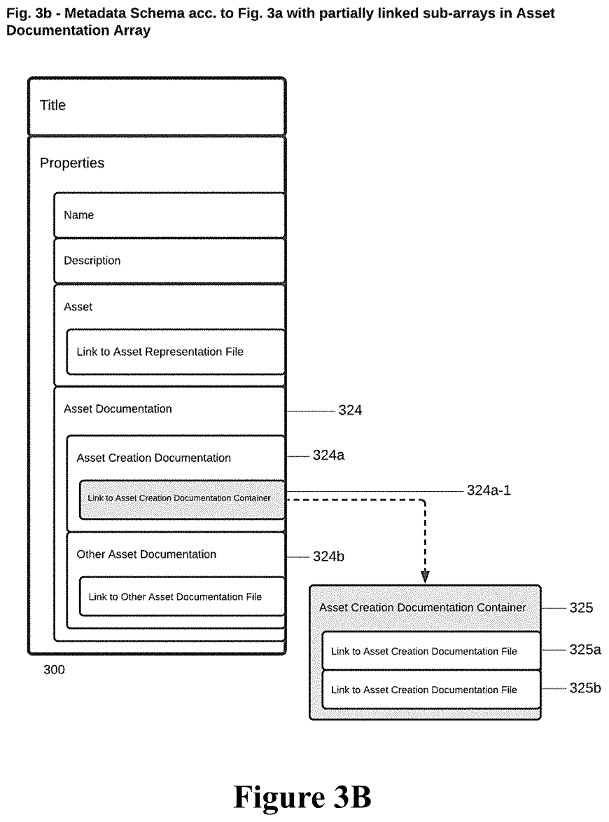

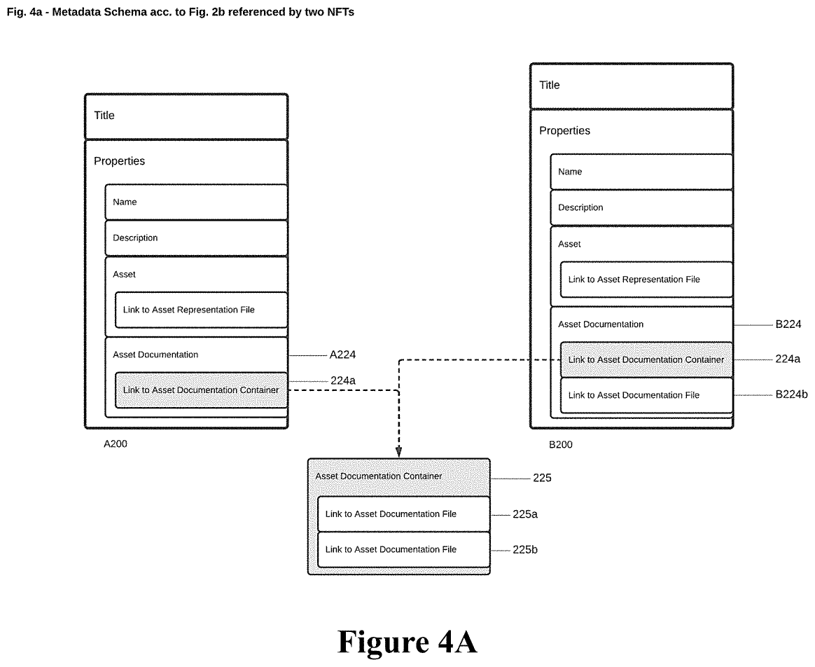

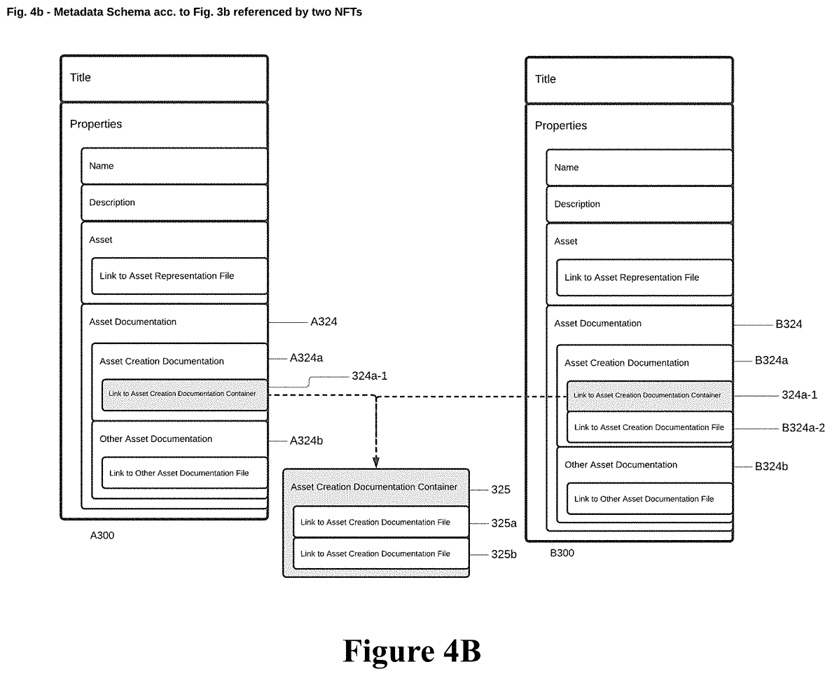

FIG. 2B is structurally basically identical to FIG. 2A but shows by way of example that the pointer 224A in the Asset Documentation Array 224 does not necessarily have to point to individual document files but can, instead or complementarily, point to further documents containing the actual links to the documentation files. In FIG. 2B, the link 224A points to an Asset Documentation Container 225, e.g. another JSON file, which contains the two Asset Documentation Files 225a and 225b. This exemplary embodiment provides more flexibility to structure and retrieve the relevant documentation files efficiently and can be used to create synergies as will be shown below with regard to the exemplary use case illustrated in FIG. 3B.

For the sake of clarity, the Asset Documentation Array can be exclusively used for chain of custody documentation or split into sub-arrays wherein e.g. one or more sub-arrays may be used for the chain of custody documentation. Such an infrastructural design is illustrated exemplarily by FIG. 3A. This embodiment is structurally related to the embodiment displayed in FIG. 2A. As in FIG. 2A, the Asset Documentation Array 324 is located in the Properties array 320 of the metadata document 300 and does not point to a separate Asset Documentation Container. It is well-understood by the skilled person—and illustrated in FIGS. 2B and 3B—, that it is possible to have the full Asset Documentation Array (as e.g. in FIG. 2B), or some sub-arrays of the Asset Documentation Array (as e.g. in FIG. 3B), or all sub-arrays of the Asset Documentation Array, point to separate documents. Different to FIG. 2A, the Asset Documentation Array 324 is, however, split into two sub-arrays—the Asset Creation Documentation array 324A and the Other Asset Documentation array 324B. In this example, the Asset Creation Documentation array 324A contains the files related to the origin of the tokenized unique asset to provide a dedicated source for the chain of custody until the act of minting. Such documents could e.g. be screenshots, videos, images, etc. In FIG. 3A, the Asset Creation Documentation array 324A contains the link 324A-1 pointing to an Asset Creation Documentation File. The Other Asset Documentation array 324B contains the link 324B-1 pointing to an Other Asset Documentation File, which can basically be any other contextual document that is not, or at least not completely, related to the asset creation process.

In FIG. 3B, the Asset Documentation Array 324 is split into an Asset Creation Documentation array 324A and an Other Asset Documentation array 324B, as in FIG. 3A. Instead of containing a link to an Asset Creation Documentation file (as in FIG. 3A), the Asset Creation Documentation array 324A of FIG. 3B provides an example for the modularity of the infrastructure as mentioned above and features an Asset Creation Documentation Container 325 that is pointed to by the link 324A-1 recorded in the Asset Creation Documentation array 324A. The Asset Creation Documentation Container 325 contains the pointers to two Asset Creation Documentation Files—the links 325a and 325b.

As mentioned above, it is also possible that the Asset Documentation Array is not maintained directly in a subsection of the metadata record of an NFT but that the Asset Documentation Array in the metadata record of an NFT merely contains a pointer to another digital document (which can also be the metadata document of another NFT). The advantage of such an approach as illustrated by way of example in FIGS. 4A and 4B. An Asset Documentation Array, or containers representing this Array or sub-arrays of it—as disclosed in FIGS. 4A and 4B—can be referenced by multiple NFTs (or their underlying metadata documents) avoiding redundant data storage, which preferable from an environmental and cost perspective, and to provide flexibility to the creator in case the development/maturing process of multiple assets is captured in one chain of custody which is later referenced by more than one NFT.

A first example for such a solution is provided in FIG. 4A. Structurally, the embodiment in FIG. 4A is based on the embodiment of FIG. 2B. The Asset Documentation Array A224 in the metadata document A200 of a first NFT A contains a link 224A to a separate Asset Documentation Container 225. And as in FIG. 2B, the Asset Documentation Container 225 contains the links 225a and 225b to two Asset Documentation Files. Next to the NFT A, an NFT B exists. In the example, NFT A and NFT B share some asset documentation files (herein also referred to as “overlapping documentation”). Instead of duplicating the overlapping documentation in the metadata document B200, the Asset Documentation Array B224 can simply point to the Asset Documentation Container 225 as well (referencing the full content of the container 225 or parts of it). For this purpose, the Asset Documentation Array B224 contains the same link 224A as the Asset Documentation Array A224 and also incorporates the Asset Documentation File links 225a and 225b by reference. In addition, the Asset Documentation Array B224 contains an additional direct link B224B to an Asset Documentation File that is related only to the NFT B. Accordingly, the embodiment illustrated in FIG. 4A provides an efficient solution to point to overlapping documentation as well as to individual documentation if required.

A second example for a solution to cope efficiently with overlapping documentation is provided in FIG. 4B. Structurally, the embodiment in FIG. 4B is based on the embodiment of FIG. 3B. As in FIG. 4A, two NFTs A and B exist. In deviation to FIG. 4A, the metadata documents A300 and B300 of FIG. 4B contain Asset Documentation Arrays (A324 and B324 respectively) that are split into two sub-arrays, the Asset Creation Documentation arrays (A324A and B324A) and the Other Asset Documentation arrays (A324B and B324B). The Asset Creation Documentation array A324A in the Asset Documentation Array A324 of the metadata document A300 of the first NFT A contains a link 324A-1 to a separate Asset Creation Documentation Container 325. And as in FIG. 3B, the Asset Creation Documentation Container 325 contains the links 325a and 225b to two Asset Creation Documentation Files. As in FIG. 4A, the metadata documents A300 and B300 in FIG. 4B comprise some overlapping documentation. But because of the breakdown of the Asset Documentation Arrays A324 and B324, it is possible to specify more precisely what the overlapping documentation relates to; in FIG. 4B to the creation of the NFTs A and B. Accordingly, the Asset Creation Documentation Array B324A can simply point to the Asset Creation Documentation Container 325 as well (referencing the full content of the container 325 or parts of it). For this purpose, the Asset Creation Documentation Array B324A contains the same link 324A-1 as the Asset Creation Documentation Array A324A and also incorporates the Asset Creation Documentation File links 325a and 325b by reference. In addition, the Asset Creation Documentation array B324A contains an additional direct link B324A-2 to an Asset Creation Documentation File that is related only to the NFT B.

An exemplary use case where overlapping documentation as illustrated in FIGS. 4A and 4B can occur can be found in R&D processes: an inventor documents a new approach to solve a technical problem and stores these documents (in an encrypted fashion, of course, as this happens at the pre-filing stage) in a decentralized file storage system. When the point of conception is reached and the idea is ready to be filed as a patent application with the Patent Office, the inventor realizes that there is actually more than one invention in the inventor's findings. Hence, the inventor files two applications which are both minted into NFTs (in the Asset Array, for the sake of clarity). Both patent application NFTs can reference the stored contextual information pointing to the documentation the inventor had uploaded during the invention process. The same applies, of course, to works of art where an artist can e.g., create a whole collection of illustrations in one digital document for the sake of comparison or any other motivation, but with the intent to later slice the illustrations out of the original document into multiple files which are then minted into unique NFTs. In addition to that, the artist could record herself/himself/themselves while working on the full collection with the intent of using the on-screen-record as proof of provenance at a later point in time. Once the individual works of art are minted into unique NFTs, they can all reference the contextual documentation (here: digital document showing possession of the full collection of illustrations, and the on-screen-record of the creation process).

The Asset Array, in contrast to the Asset Documentation Array, is unique to an NFT as it represents the unique asset itself. As such, the Asset Array basically contains the link to one or more unique digital documents identifying the tokenized unique assets. The link can refer to any kind of document and source of origin, e.g., to a publicly stored document, an encrypted document, or a document stored on an internal enterprise server behind a firewall.

The interplay of the Asset Array and the Asset Documentation Array make it possible for the NFT to become maturable. There are basically two ways of achieving this. In a first series of embodiments, the maturable NFT is created as a maturable NFT right from the beginning of the documentation process, i.e. the minting takes place before the documentation starts (herein referred to as “ex ante” approach). In a second series of embodiments, the maturable NFT is created on hindsight, i.e. the minting takes place only after the documentation is concluded (herein referred to as the “ex post” approach).

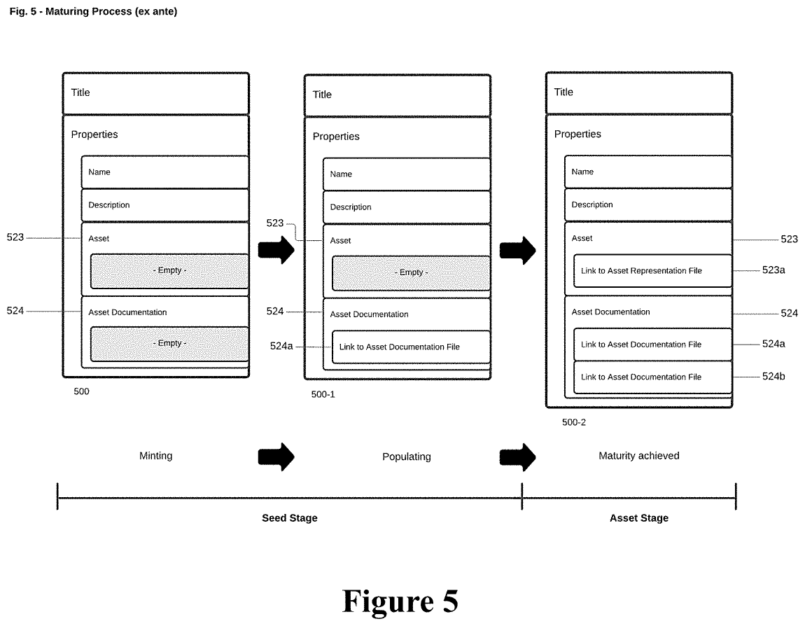

Following the ex ante approach illustrated by way of example in FIG. 5, the NFT is minted initially but the metadata document 500 does not contain any data or enough data in its Asset Array 523 and/or its Asset Documentation Array 524 yet (1^{st} maturity stage, which can be referred to as a “seed stage”). As long as this is the case and there is no data in the Asset Array 523, the NFT cannot be re-assigned or transacted with. To provide additional security for potential transaction partners, this can be safeguarded by a smart contract, a decentral protocol, or an alike security measure.

The NFT creator starts to populate the Asset Documentation Array with evidence of the asset origin by uploading documents (for example screenshots of digital assets being created, screenshare videos of the creation of the digital asset, pictures documenting the creation process of a physical artwork that is supposed to be tokenized once completed) in a manner that timestamps these documents reliably and is suited to provide proof of the content of a document. This can be done, by way of an example, by uploading the contextual information/documentation to an immutable distributed file storage repository like the InterPlanetary File System (IPFS) or any storage service built on top of such immutable distributed file storage repository (FileCoin, Pinata), or any of the point solutions mentioned in the description of the prior art approaches above. Depending on the confidentiality level of the uploaded documentation, the creator either uploads the documentation directly (public upload), encrypts the document before uploading it (confidential), or merely uploads a hash representing a specific document that can be retrieved from a non-public source only (strictly confidential). For works of art, be it of digital or physical origin, or any kind of memorabilia, public storage will likely be the preferred upload option as it validates ownership in an easy and reliable manner. For trade secrets and industrial property, confidential upload mechanisms will be required.

The aforementioned step is illustrated as the second step in FIG. 5 with reference to the metadata document 500-1. While the Asset Array 523 is still empty (or not sufficiently populated), the Asset Documentation Array 524 comprises a first link 524A to an Asset Documentation File.

The Asset Documentation Array, or any suitable sub-section of it, continues to be populated in the abovementioned manner. When the asset is matured enough, the Asset Array is populated in a final step with the document containing the final asset (2^{nd} maturity stage, which can be referred to as the “asset stage”). This step is illustrated as the third step in FIG. 5 with reference to the metadata document 500-2. The Asset Documentation Array 524 now comprises the two links 524A and 524B to Asset Documentation Files, and the Asset Array 523 comprises a link 523A to an Asset Representation File. The NFT can be re-assigned or transacted with if no additional maturity prerequisites need to be achieved (see below).

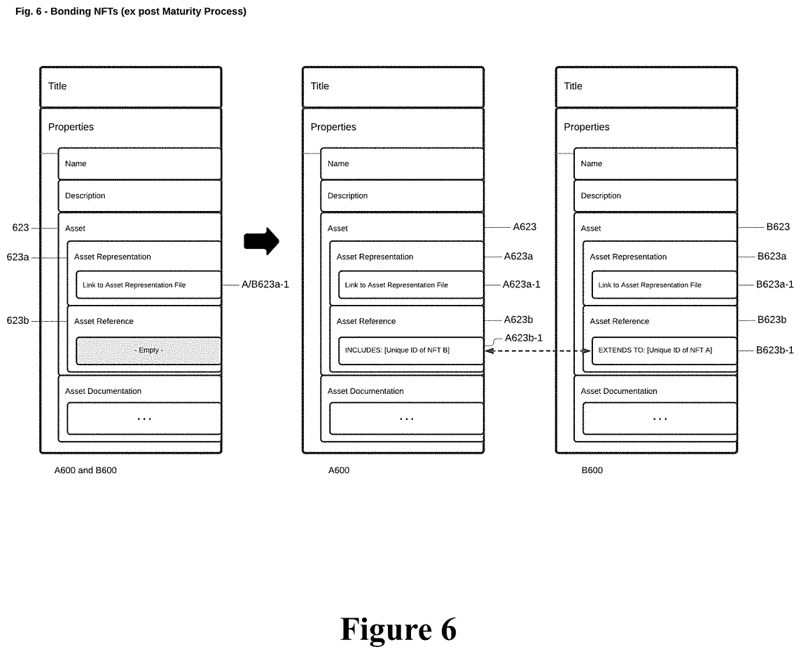

The skilled person understands that the maturity process in FIG. 5 is only an example. Of course, the process can feature intermediate and/or subsequent steps, and the metadata document structure can deviate from the one displayed in FIG. 5 (e.g., resemble the ones presented in FIGS. 2A to and including 4B, and/or FIG. 6, or the like).

Depending on the requirements of the respective NFT ecosystem, the final population of the Asset Array of an NFT is either permissible without any additional security restrictions (“unrestricted maturity”), or can only be allowed once sufficient asset maturity is determined (“maturity determination”). With regard to works of art, it may e.g., be preferable to leave full control for the determination of the asset maturity to the creator. In such a scenario, the creator can decide when the point in time to populate the Asset Array is reached, population the Asset Array, and subsequently trade or transact the matured NFT. In other scenarios, e.g., in Industrial Property, or namely in patent law, the premature creation of NFTs can be detrimental to the NFT's value and it may be preferable to put a mandatory maturity threshold in place, e.g., a required minimum technology or invention maturity level. Whether the set threshold is met can either be determined manually or by an algorithmic assessment of the uploaded contextual information in the Asset Documentation Array, or a combination of both.

As an optional feature, the Asset Documentation Array can, at the option of the NFT creator, be locked or frozen to safeguard that the chain of custody stored therein cannot be tempered with once the point in time when the Asset Array is populated is reached, and the NFT is considered being matured. This is preferably done by hashing the full Asset Documentation Array document, if the Asset Documentation Array is a document separate to the NFT metadata document. But even more preferably, the chain of custody documentation until the point in time of the NFT maturity is stored as a separate document linked to in a dedicated sub-array of the Asset Documentation Array (as mentioned above), wherein only said document is hashed and immutably stored at the point in time of the NFT maturity, while the Asset Documentation Array, or other sub-arrays of it, can still be used to capture subsequent ownership-related documentation of the NFT.

The ex post approach also needs further elaboration. There are two fields of application for documentation being added to an NFT on hindsight, i.e. after the Asset Array, or any comparable field of an NFT metadata document, is populated.

Firstly, an NFT can already have been minted with at least one asset being designated as the unique asset the token represents in the Asset Array (and is thus fully transactable)—but without or with only incomplete data in the Asset Documentation Array. In this case, the NFT owner has an interest in populating the Asset Documentation Array on hindsight to resolve any potential concerns regarding the provenance of the asset by either (1) uploading documents into the Asset Documentation Array, or any dedicated sub-array of it, in a timestamped manner for the first time, or (2) linking previously uploaded and timestamped documents to the Asset Documentation Array by referencing one or more unique identifiers representing these documents (e.g., hash codes), or (3) a combination of the two aforementioned approaches, in order to create a chain of custody as complete as possible for an already existing/minted (and thus fully transactable) NFT.

Secondly, it is possible that an owner of two or more NFTs, or multiple owners of two or more NFTs, decide(s) at some point that two or more (mature or premature) NFTs should be aggregated into one “leading NFT” that controls the transaction behavior of the underlying aggregated NFTs (also described as “referenced NFTs”). This can be the case if assets were minted to NFTs prematurely (or as described above with regard to prior art solutions to capture ownership as a result of the current unavailability of maturable NFTs on the market) and are sought to be aggregated later. In such scenario where a retrospective roll-up of existing NFTs is required, the Asset Arrays of the referenced NFTs basically provide the contextual information to the leading NFT. In such case, additional information about the NFT hierarchy relationship between the leading NFT and the referenced NFTs is included into both the leading NFT's metadata document and the referenced NFTs' metadata documents, e.g., directly in the Asset Array or in a sub-array of the Asset Array (for example an “Asset Reference Array”). The status of a leading NFT is preferably expressed by listing the referenced NFTs' unique token IDs in an “INCLUDES” field of the reference or relationship information, while the status of referenced NFT is preferably expressed by listing the leading NFT's unique token ID in an “EXTENDS TO” field of the reference or relationship information. It is understood that such reference information can also be directly integrated in the Asset Array of NFTs and that the invention is not limited to the concept of creating two separate arrays.

The second field of application for the ex post approach is illustrated by way of example in FIG. 6. In this example, there are two NFTs, NFT A and NFT B. Both NFTs contain Asset Representation Files (A623A-1 for NFT A, and B623A-1 for NFT B) in the Asset Arrays 623 of their respective metadata documents A600 (for NFT A) and B600 (for NFT B). The owner(s) of the two NFTs seek to aggregate them into one leading NFT, and a referenced NFT wherein NFT A is supposed to become the leading NFT while NFT B is supposed to become the referenced NFT. In FIG. 6, this functionality is provided by the exemplary structure of the Asset Arrays 623 of the two NFTs as these Asset Arrays 623 are split into an Asset Representation array 623A and an Asset Reference array 623B, respectively. Initially, the Asset Reference arrays 623B are empty while the Asset Representation arrays 623A comprise the respective links A623A-1 (for NFT A) and B623A-1 (for NFT B) to Asset Representation Files.

In FIG. 6, the ex post hierarchy is established by mutually recording it into the Asset Reference arrays A623B and B623B. Upon consensus between the owner(s) of NFT A and NFT B, evidenced e.g., by a signature using their respective keys, the Asset Reference array A623B of NFT A is updated with the reference field A623B-1, expressing that the leading NFT A “INCLUDES” the referenced NFT B, wherein NFT B is uniquely identified by its unique token ID. The Asset Reference array B623B of NFT B, in turn, is updated with the reference field B623B-1, expressing that the referenced NFT B “EXTENDS TO” the leading NFT A, wherein NFT A is uniquely identified by its unique token ID. The hierarchical relationship is now recorded in both NFT metadata documents A600 and B600, and can e.g., be processed automatically by smart contracts. Such smart contract could comprehend, for example, that the Asset Representation File of NFT B (pointed to by link B623A-1) is of contextual relevance for NFT A but of fundamental relevance for NFT B.

Accordingly, the currently existing drawbacks in the prior art are overcome by the abovementioned method to establish a maturable non-fungible token recorded on a blockchain and referencing a, and or relying on, an extendable chain of custody, wherein said chain of custody itself comprises at least one blockchain record, and wherein said chain of custody can be referenced by, or relied on by, one-to-many non-fungible tokens; and/or by adding hierarchical relationship information to NFT metadata documents.

As mentioned above, the second main drawback of existing NFTs is the uncertainty around the allocation of Intellectual Property (IP) rights, especially regarding the assignment of IP commercialization rights and the scope of such assignment (if any).

These existing drawbacks relating to IP right allocation can be overcome technically by the creation of interoperable IP tokens that are either created together with (but independent from) an NFT or added to existing NFTs to clarify the IP right allocation. a maturable non-fungible token recorded on a blockchain providing a carefully dosed amount of flexibility in terms of the substantive scope of the NFT.

As mentioned with regard to the current problems of NFT owners (mainly buyers that are not the original creators of an NFT and/or the underlying asset) and parties interacting with NFT owners, uncertainty arises basically on three levels. Firstly, it is unclear to the NFT owner and parties interacting with the NFT owner, to what extent the NFT owner is entitled to use the NFT commercially and/or to exploit the IP rights allocated with the NFT (if any), e.g., (sub-)licensing rights, assertion of exclusivity against third parties. Secondly, it is difficult to determine whether a copy of a digital asset or an embodiment of a physical asset is infringing IP rights in various scenarios of use as the uncertain IP right allocation going hand in hand with current NFTs can cause major confusion as to which acts of use are licensed and which are not on a case-by-case level. Thirdly, it is not economically viable to sort out manually which acts of use are actually licensed and which are not, and to pursue cases of infringement, as decentralized use cases can result in collective infringement by many stakeholders acting together (intentionally or negligently) providing micro-contributions to the act of infringement, and/or in distributed infringement across a number of jurisdictions by a large quantity of individual players (micro-infringement)—a situation that will arise more often as as we are heading into the “Metaverse” as recently announced by Facebook's (now: Meta's) founder Mark Zuckerberg, where users will be represented by digital avatars in a virtual environment.

The first step to the solution to the aforementioned problems and challenges lies in the acceptance that the NFTs as they are commonly traded on the platforms these days are nothing more than “title” NFTs with a corresponding digital ownership allocation—and that this conclusion is one of merit. Instead of trying to solve both challenges at once, the one regarding ownership and proof of provenance, and the one regarding the IP rights allocation per NFT, the creation of a dedicated IP token scheme being interoperable and even retrofittable with the current title NFTs is the preferable technical solution for futureproofing the NFT ecosystem. Separating the title token from the IP token—which will be specified in more detail below—has many advantages over the solutions applied in the prior art. Firstly, the assignment of IP rights can be, but is by no means mandatorily, connected to the ownership of an asset. As such, the IP rights package can be traded, in principle, without the underlying asset. This is reflected more accurately if the title NFT is contractually interwoven with an IP token but if the two remain separate tokens. Secondly, the IP rights assignment may vary largely per use case and allow, e.g., for the creation of child tokens like licenses granting a temporarily limited right of use as will be specified in more detail below.

Such an innovative IP token scheme is disclosed in the following:

To start off with, an IP token requires—independent of the kind of IP token—a connector to an existing NFT of any give origin (herein referred to as a “title NFT”), that does not require any infrastructural changes to the title NFT itself.

This is achieved infrastructurally by linking the IP token—independent of the kind of IP token—to the unique title NFT ID. How this link is established depends on the current IP rights and ownership situation.

In a first exemplary use case, the title NFT is owned by the creator, i.e. title of the asset and the IP right ownership are still in the same hands (ex ante linkage). In this use case, the title NFT can basically be used to create an IP token.

In a second exemplary use case, the title NFT has already been assigned to a new owner (buyer) while the creator still owns the IP rights to the asset (ex post linkage). In this use case, the title NFT can no longer be used to create the IP token but requires an additional rights assignment from the original creator of the NFT.

What both exemplary use cases have in common is that the wallet ID (public key) of the original creator of the title NFT is known. Unless the title NFT was created by an unauthorized third-party in the first place, the user minting the title NFT corresponds to the creator of the NFT.

As a conclusion, the most promising approach for linking asset title to IP right ownership is via the wallet ID (public key) that has minted the title NFT (herein referred to as the “original minter”). The question whether the original minter of the NFT actually owns the IP rights to the minted asset is—just like the proof of provenance addressed with regard to the chain of custody and maturable NFTs above—a question of IP rights ownership verification.

Thus, interoperability between the IP token and the title NFT can be established—ex ante or ex post—by requiring the signature of the original minter to clear the transaction. Accordingly, the IP token preferably references by design both the unique ID of the title NFT and the wallet ID (public key) of the title NFT's minter immutably in its own asset ID.

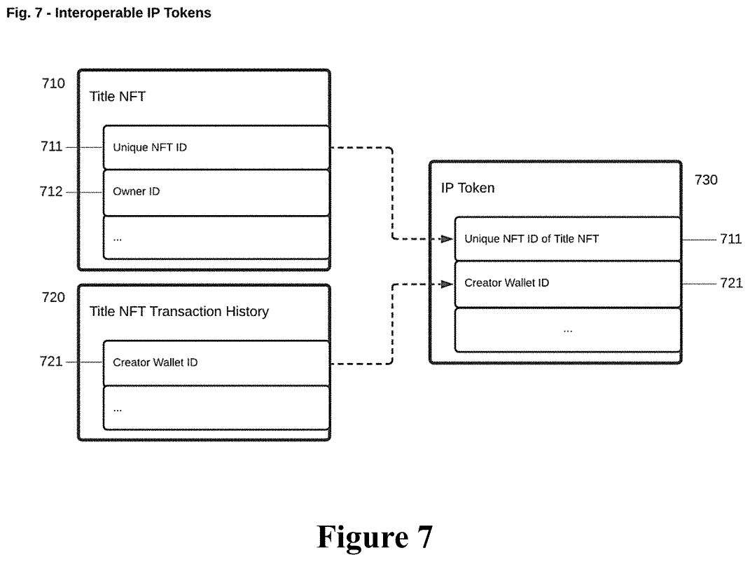

The aforementioned linking process is outlined by way of example in FIG. 7. The Title NFT 710 comprises at least the Unique NFT ID 711, and the Owner ID 712. As NFTs are blockchain-native, their transaction history can be derived from the blockchain itself. Accordingly, the Transaction History 720 of the Title NFT 710 can be queried and tracked back to the first wallet ID that the minted NFT was originally assigned to, the Creator Wallet ID 721. Based on this available information, the IP Token 730 can be minted. Preferably, the IP Token 730 refers immutably to the Unique NFT ID 711 of the Title NFT 710, and the Creator Wallet ID 721 of the Title Token 710. It is also possible to record the Unique NFT ID 711 of the Title Token 710, and the Owner ID 712 of the Title Token 710 in the IP Token 730— or both, Creator Wallet ID 721 and Owner ID 712— as long as the minting authority for the IP Token is confident, that the selected ID is attributed to the actual IP rights owner of the tokenized unique asset with a sufficient degree of reliability.

The additional content of the contract to create an IP token will be discussed in more detail below.

Before any IP token is created, the IP right ownership should be verified by the entity or institution creating said IP token to avoid potential abuse. The background of the verification process is to check whether, or at least to what degree of probability, the original minter of the title NFT also holds the IP rights to the tokenized asset, and to what extent, and whether these rights are transferable. The verification process can either be undertaken manually or by an algorithmic assessment of recorded information (e.g., ownership-related documentation in the Asset Documentation Array of an NFT as described above, or comparable information either pulled from a public register or provided by the original minter, or a combination of both), or a combination of both.

If the IP right ownership verification clears, the IP token can be created. As a security provision, the ownership verification result, and even more preferably the ID of the entity or institution creating the IP, should be recorded in the IP token.

For the sake of clarity, the terms “entity or institution” in this document should be understood to cover centralized entities or institutions or consensus-based distributed institutions as will be prevailing with the rise of the so called Web 3.0. The term “IP token” can be referring to a non-fungible token (NFT) or a fungible token, depending on the respective use case and the scope of the assigned rights as will be specified in more detail below.

In terms of their content, the tokens generally referred to herein as “IP tokens” can vary depending on the scope of the right assignment constituted therewith. An IP token can have non-fungible characteristics or fungible characteristics, or even a combination of both, depending on the scope of the granted rights, as will be detailed in the following section.

According to a first type of embodiments, an IP token can be designed technically as an IP Control Token with characteristics of an NFT. The IP Control Token is a unique asset, e.g., if it represents—inter alia—the IP right ownership corresponding to the specific tokenized asset that the title NFT relates to (be it a physical asset or a digital asset); or an exclusive license to the IP rights in regard to a to the specific tokenized asset that the title NFT relates to (be it a physical asset or a digital asset), with or without the right to sub-license; a non-exclusive license with the right to grant sub-licenses; or a combination of ownership transfer (e.g., fractional ownership), and/or the assignment of an exclusive license, and/or a non-exclusive license with the right to grant sub-licenses.

The abovementioned exemplary use cases can be subjected to various limitations like a “field of use” limitation, a quantitative limitation of the right to create copies of the specific tokenized asset that the title NFT relates to for non-private use, a quantitative limitation of the right to sub-license, and temporal limitations. The limitations are recorded in the IP Control NFT itself immutably in a manner that prohibits the transferred IP rights from being extended without the consent of original IP rights owner (corresponding with but not necessarily limited to the original minter of the title NFT). Limitations to the rights to create copies for non-private use and/or the right to sub-license the IP rights, can help ensure that the authorized distribution of the asset that the title NFT relates is limited. This is a crucial attribute to any title NFT as title NFTs typically derive their value largely based on scarcity.

IP Control Tokens can optionally be equipped with additional right assignments and/or licenses, e.g., with digital files that are suitable or helpful to recreate digital or physical objects in other digital, virtual or physical environments like the Metaverse. In this optional use case, the IP Control Token owner does not only receive the right to, or to use, an IP right but is also supported in recreating the asset that the title NFT relates to in any given environment. This is preferable from a marketing perspective and from the perspective of appraising the asset itself properly in any give environment. From the perspective of the owner of the asset that the title NFT relates to this is preferable if he/she/they is/are also the owner of the IP Control Token or a licensee of the owner of the IP Control Token as this additional right grant extends the freedom to use the asset enormously, e.g., by providing the possibility to transfer the asset between different digital/virtual worlds.

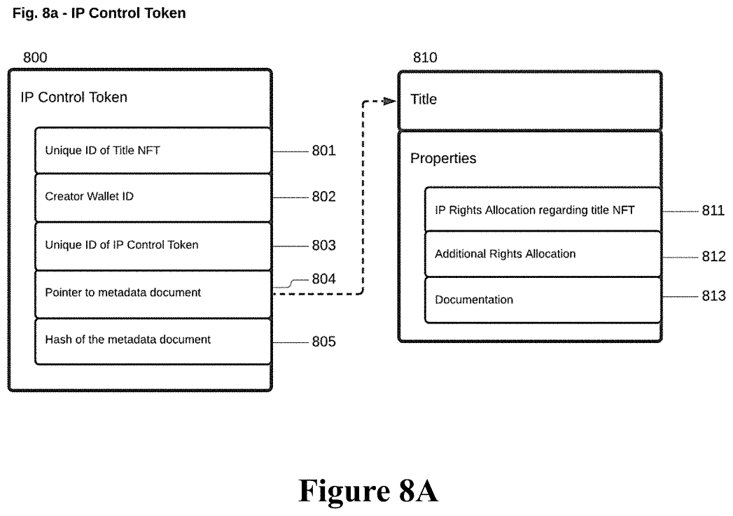

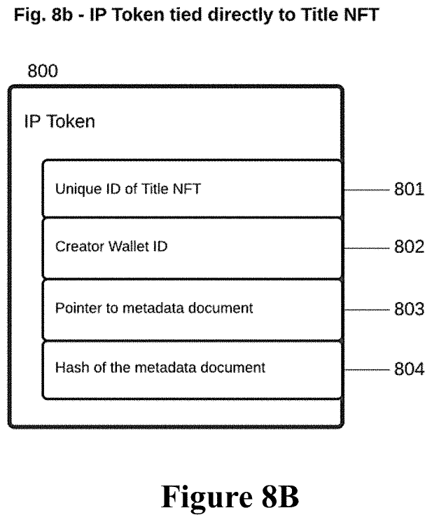

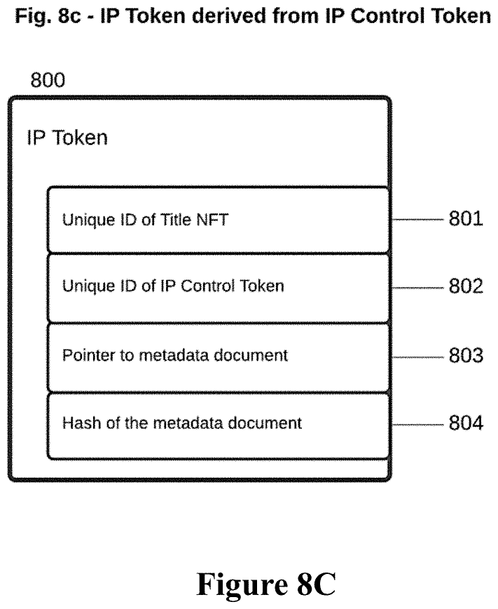

An example of an interoperable non-fungible IP Control Token is illustrated in FIG. 8A. The IP Control Token 800 comprises a reference 801 to the Unique ID of the corresponding Title NFT, and a reference 802 to the Creator Wallet ID, as both title NFT owner and the original IP rights owner (represented by the Creator Wallet ID) are required to bring the IP Control Token 800 into existence. Further, the IP Control Token 800 comprises an own unique ID 803. This own unique ID is especially relevant when the IP Control Token may grant sub-licenses as the IP Tokens representing these sub-licenses refer to the IP Control Token (see FIG. 8C). Further, the IP Control Token 800 contains a Pointer 804 to the metadata document 810, and can contain a Hash 805 of the metadata document 810. Hash 805 can safeguard the immutability of the metadata document 810.

The metadata document 810 displayed in FIG. 8A can be of any suitable format and structure as disclosed above with regard to maturable NFTs. In the metadata document 810, the IP Rights Allocation 811 regarding the asset that the title NFT relates to is recorded. The IP Rights Allocation 811 can comprise any and/or any combination of the abovementioned range of allocatable IP rights and/or limitations thereof. The array Additional Rights Allocation 812 can cover other right assignments enabling or improving the use of the asset that the title NFT relates to, e.g., the abovementioned copyrights to additional image files. The array Documentation 813 can be used to point to online storage repositories where additional documentation files and/or related files are stored, e.g., PDF documents regarding the provenance of IP right ownership, or digital files representing the asset that the title NFT relates to (like renders of in-game objects, renders of memorabilia, etc.).

According to a second type of embodiments, an IP token can be designed technically as an IP Token with characteristics of a fungible token. The IP Token is not a unique asset as it is basically interchangeable, e.g., if it represents a simple non-exclusive license without the right to sub-license. Here also, the exemplary use case can be subjected to various limitations like a “field of use” limitation, a quantitative limitation of the right to create copies of the specific tokenized asset that the title NFT relates to for non-private use, and temporal limitations. The limitations are recorded in the IP Token itself immutably in a manner that prohibits the transferred IP rights from being extended without the consent of original IP rights owner (corresponding with but not necessarily limited to the original minter of the title NFT).

Just like IP Control Tokens, IP Tokens can optionally be equipped with additional right assignments and/or licenses, e.g., with digital files that are suitable or helpful to recreate digital or physical objects in other digital, virtual or physical environments like the Metaverse. In this optional use case, the IP Token owner does not only receive the right to use an IP right but is also supported in recreating the asset that the title NFT relates to in any given environment. This is preferable from a marketing perspective and from the perspective of appraising the asset itself properly in any give environment. From the perspective of the owner of the asset that the title NFT relates to this is preferable if he/she/they is/are also the owner of the IP Token as this additional right grant extends the freedom to use the asset enormously, e.g., by providing the possibility to transfer the asset between different digital/virtual worlds.

An example of an interoperable IP Token is illustrated in FIG. 8B. The IP Token 800 comprises a reference 801 to the Unique ID of the corresponding Title NFT, and a reference 802 to the Creator Wallet ID, as both title NFT owner and the original IP rights owner (represented by the Creator Wallet ID) are required to bring the IP Token 800 into existence (if the IP Token is not derived from an IP Control Token, see below FIG. 8C). Further, the IP Token 800 contains a Pointer 803 to its metadata document, and can contain a Hash 804 of its metadata document. The metadata document is not illustrated in FIG. 8B but reference is made to the explanations regarding the metadata document 810 in FIG. 8A.

In the case an IP Control NFT provides the right to sub-license to its owner, these sub-licenses may be represented by IP Tokens assigned to the sub-licensees. In case of a quantitative limitation of the right to sub-license, the IP Control NFT enforces that only the contractually agreed amount of IP Tokens can be generated from it. In case of a temporal limitation of the license and/or sub-license grant, the IP Tokens are redeemed automatically as soon as the license/sub-license period expires—or at an earlier point in time, e.g., if the licensee/sub-licensee is in default with the license payment and a smart contract, or the (sub-)license right holder terminates the (sub-)license at an earlier point in time.

An example of an interoperable IP Token that is derived from an IP Control Token is illustrated in FIG. 8C. The IP Token 800 of FIG. 8C comprises a reference 801 to the Unique ID of the corresponding Title NFT, and a reference 802 to the Unique ID of the IP Control Token. A pointer to the Creator Wallet ID is not mandatorily required as this information is comprised in the IP Control NFT that reference 802 points to already. Further, the IP Token 800 contains a Pointer 803 to its metadata document, and can contain a Hash 804 of its metadata document. The metadata document is not illustrated in FIG. 8C but reference is again made to the explanations regarding the metadata document 810 in FIG. 8A.

For IP Control Tokens, specific arrangements regarding the allocation of royalties to the original creator, or more specifically to the original creator's Wallet ID (public key) as it is known and recorded in the IP Control Token in any case, can be pre-defined by recording such allocation arrangements in the IP Control Token itself. Accordingly, it can e.g., be possible for the original creator to redeem a lumpsum fee, or a share of the purchasing price, for each digital copy that is created from the originally tokenized asset under an IP license. The payment can be effectuated automatically at extremely low transaction costs using smart contracts.

Optionally, IP tokens of either kind can be plugged into an automated dispute resolution mechanism, suited to automatically analyze and resolve IP infringement allegations. The IP token then serves—like a key—as a right to use for one specific the asset equipped with it and, thus, confirms that the production, import, marketing, and using of an asset—be it a virtual or physical good—is not infringing specific IP rights. For this purpose, IP tokens can be represented on each copy of the asset in a graphical or any other computer-readable manner, e.g., a QR code or a barcode or even a single pixel positioned at a specific predetermined position.

Hereinafter, some additional exemplary use cases for interoperable IP tokens and the interplay between IP Control NFTs and IP Tokens are illustrated. The invention is expressly not limited to these use cases.

Generally, by endowing a title NFT with additional rights related to an artwork, an in-game item, or to memorabilia, by connecting the NFT to a license that meets both, the intentions of the NFT creator/author of the originally tokenized work as well as, to the extent possible and desired, of the NFT buyer, the NFT will benefit in its value. Furthermore, potential later disputes concerning IP right issues and/or other rights connected to the NFT may—at least to a certain extent—be avoided.

Interoperable IP tokens bring a whole new dimension to digital and virtual ecosystem and are ready for the next big push of the web into the so-called Metaverse. As mentioned with regard to prior art solutions, the current mere title NFTs are of little use for the users. Digital art without IP rights can be displayed privately at home or on a personal smartphone but it cannot be used securely for presentation to a wider audience. If future art and goods that were formerly only present as physical goods are, at least partially, displayed in cyber fairs, virtual showrooms, virtual workplaces, virtual shopping malls, virtual cities, and other yet to be discovered use cases, these use cases will be as transformational as the internet was for the printing industry and media—and pose major new challenges to IP right enforcement. A parallel virtual universe is on the rise and creators will be confronted with new types of IP infringement like the distributed use of peer-to-peer networks at the end of the 1990s and in the early 2000s. Legal certainty is key in this new realm and it can be provided reliably by IP tokens.

IP tokens can evade the allegation of IP right infringement as they are derived directly from the IP right owner or indirectly from IP Control NFTs allowing sub-licenses. Like a key to a car or a house, an IP Token grants access to carefully specified use cases for specified digital goods. Without scarcity controlled through IP Control NFTs, uniqueness can hardly be achieved in a virtual dimension. But artificial scarcity is exactly what provides the economic chances for creators in the future.

At the same time, IP tokens—independent of their kind—provide a chance to outlast the environment that they were originally created for and in. A good example is the one of an in-game item that survives the shutdown of a game. In-game items for World of Warcraft, League of Legends, and Fortnite can be traded already today in the form of NFTs and can be used in these dedicated virtual environments as part of the license to the game itself (even though the offer of such NFTs on public platforms can constitute a case of IP infringement). But after the games are shut down, the companies and user accounts are closed potentially forever and the proprietary source code underlying the tokenized items is lost. By assigning IP licenses to the owner of in-game objects against reasonable royalties, allowing the reproduction and use in other virtual environments—while at the same time enforcing scarcity, e.g., through the automated dispute solution mechanisms checking for IP tokens as positive rights to use as described above—new markets for historic artefacts are created, the memories of the community outlast the game. As mentioned above, licensing the digital files that are suitable or at least helpful to recreate digital or physical objects in other digital, virtual or physical environments like the Metaverse, is supporting accurate (historical) representation, and the future of virtual branding. This is preferable from a marketing perspective and from the perspective of appraising the asset itself properly in any give environment.

The same is true for memorabilia, like sports or movie memorabilia. There may be use in buying a digital copy of physical memorabilia, for example an Aston Martin specifically designed for and shown in a James Bond movie. But licensing the right to recreate this specific Aston Martin digitally and accurately, and potentially driving it in a virtual world—or even importing it into a game of the future—adds a whole new dimension to the potential use cases of memorabilia. All this is enabled by the invention disclosed herein, by combining title NFTs with IP tokens.

The two transformational innovations for the NFT space disclosed herein can be applied together as will be discussed in the following exemplary embodiment. Before a digital artwork is created on a digital canvas, e.g., in Adobe Illustrator, a maturable NFT is minted. Each drawing operation on the digital canvas can be logged together with the date of the creation and the personal ID of the computer or tablet that the drawing is created on, supplemented by on-screen video footage and additional evidence if requested by the creator, e.g., recorded selfies. Instead of auto-saving or manual saving operations, the evidence is synchronized to IPFS and stored in a decentralized manner. The storage locations are recorded in the sub-array “Asset Creation” of the maturable NFT's Asset Documentation Array.

Once the digital artwork is considered completed by the artist, it is exported e.g., as a vectorized image into the Asset Array of the maturable NFT. The Asset Creation sub-array of the Asset Documentation Array is hashed and sealed immutably.

Since the maturable NFT is considered matured by its creator, the NFT is greenlighted for transactions. To add additional value to the NFT, the creator links the (title) NFT to an IP Control NFT with the settings that the digital artwork may be reproduced up to five times for an unlimited licensing period against a one-off payment of USD 5,000 to the creator per reproduction. The ownership of the IP rights to the digital artwork is verified automatically be a decentralized protocol reviewing the Asset Creation sub-array of the title NFT's Asset Documentation Array. Once verified, the IP Control Token is minted and the digital artwork can be sold on a digital marketplace.

Innovate.io is a collaborative innovation platform that leverages ground-breaking technologies developed by the leader in IP and blockchain, IPwe, including non-fungible tokens (NFTs) tokenizing intellectual property and a global patent registry. With the new Innovate.io token and platform bringing together innovation actors such as patent attorneys, lawyers, technical experts, researchers, investors and more, small innovators anywhere in the world will have the ability to promote, evaluate, enhance, protect or share freely, develop, finance and commercialize innovative ideas globally, simply, safely, at a fraction of today's cost.

The system that underpins global innovation today to encourage, identify, protect and promote innovation, has spurred an unprecedented wave of innovation in the last century, best epitomized by the increasing, and self-reinforcing pace of disruptive innovations. But this system, designed and built in developed countries, allows large enterprises to create entry barriers in an era of globalization, and fuel increasing inequalities.

The global innovation system still depends on complex laws understood by a select few, manual reviews and traditional information systems resulting in exclusive and time-consuming processes. Small innovators suffer from information asymmetry and lack the time to navigate such complex processes. The transaction costs to create, refine, develop, protect and commercialize innovation are staggering, and driven up by centralization. Capital allocation largely ignores most of the developing world, further driving these costs up and further fueling inequalities in the innovation ecosystem. Great ideas that lead to improvement in the human condition are not the exclusive provenance of large corporations based in a handful of countries. Yet centralized innovation systems that prevail today benefit the latter. Intangibles such as R&D expenditure or goodwill for instance, are often listed on the balance sheets of enterprises but much less so by SMEs who are more concerned with growth than moats. Innovation arises bottom-up through the ingenious efforts of individuals and small teams, but today's innovation systems are designed top-down by regulators and lobbyists and guided by large enterprises. As a result, these innovations create more value for corporate shareholders than for those creators at the source of innovation. Individual and small innovators are ignored or left to struggle in a system that is just not aligned with their resources and capabilities.

The global system underpinning innovation should reflect the decentralized nature of innovation. This was not possible until very recently, and it is thanks to technological progress led both by large enterprises and individual innovators such as Satoshi Nakamoto, that it is possible today to break open an entirely new innovation market.

Combining two of the leading technologies of the 4th Industrial Revolution, blockchain and artificial intelligence, it is possible to drastically reduce the costs and complexity historically associated with innovation. A marketplace leveraging these technologies to provide innovation stakeholders access to information, protection, capital, and a trusted network of global partners can make it possible for millions of innovators to enter the global innovation market. The socio-economic benefits are immense. For instance, a startup's first patent application approval can lead to an increase in growth of employment by 36% and an increase in sales by 51% on average for the next five years³. ³ Farre-Mensa, J. and Hegde, D. and Ljungqvist, A. (2016) The Bright Side of Patents. NBER Working Paper No. w21959, Available at SSRN: https://ssrn.com/abstract=2729060

Going further, the cross-fertilization of ideas at all stages of the innovation process, made possible in such a marketplace, will significantly increase the social efficiency⁴ of today's global innovation system, and reduce the constraints of geographical proximity. Indeed, from the very early stage of ideation, innovators have to face the trust dilemma of sharing their ideas and losing intellectual property. Blockchain, in particular non-fungible tokens (NFTs), makes it simple and cost-efficient enough for innovators to share their ideas without losing intellectual property, allowing them to refine and improve their innovation safely with others, independently of their location. ⁴ Von Hippel, E. (2005) Democratizing Innovation. The MIT Press.

Recent advances in artificial intelligence also provide for an effective solution to compare and evaluate innovative ideas against existing ones rapidly, limiting manual interventions, balancing information asymmetry, cutting time-consuming processes while exponentially impacting the inclusivity of today's global innovation system. Innovate.io strongly believes that innovation is not the exclusive provenance of a thousand of the world's largest corporations and that innovation is global. Individual and small innovators in any area of the world are capable of identifying a need or improvement that can be solved through innovation.

Last but not least, the tokenomics of the blockchain economy provides for reliable, scalable and secure options to foster network effects between all innovation stakeholders in ways that were just not possible until today. This assuredly will unlock global value creation while measurably expanding global innovation and improving the human condition.

Innovate.io is a decentralized marketplace to advance global innovation. It provides innovation stakeholders anywhere access to information, analytics, capital, resources and a trusted network of global partners to safely develop, protect and commercialize innovative ideas.

Innovate.io allows Innovators to empirically evaluate their ideas using artificial intelligence and then to improve ideas iteratively all whilst protecting intellectual property. Those innovations that are scored above a threshold level are rewarded with $innovate tokens. These innovations represent what are likely to be the most promising innovations that then can be protected, financed, further developed and commercialized using the Innovate.io platform.

Using the Innovate platform will allow all innovators to maximize the value of their ideas, individually or collectively, using an ever-developing array of decentralized productization services. The innovator chooses whether and where to protect their innovation and whether, when and under which terms to make it available for public or private use.

Four types of stakeholders interact within the Innovate.io marketplace: Innovators are individuals or a group of individuals who contribute to the platform with innovative ideas and seek services, financing or expertise from other platform stakeholders to bring these ideas to life. Service Providers are lawyers, patent attorneys, technical experts, research institutions, patent offices, brokers, law firms, government bodies or any other type of person/entity providing services regarding the establishment, development, and refinement of innovation. Partners are financial organizations and individuals that can fund Innovators, enterprises interested in commercializing Innovators' ideas or universities seeking to further their research. Investors are individuals and entities who are seeking earlier stage opportunities where outsized social and financial returns typically reside. The Innovate.io Association, a Swiss nonprofit organization, oversees the launch and decentralization of the Innovate.io platform and $innovate token.

The present invention is a chain of custody (CoC) solution for public patent data records using blockchain wherein all information moving to the public blockchain is encrypted by default. The encrypted information uses a key generated by a certificate manager, and the user initiating the transfer of the information to the public blockchain is able to identify parts of the information that could be selectively decided to be kept accessible to the public, such as ownership information for a patent asset.

The present invention uses public blockchain to store, secure, and trace patent data. The result is a paradigm shift in the application and role of patents in finance, technology, and enterprise. Intellectual Property (IP) is the largest and often most critical asset on most corporate balance sheets. Corporations are taking a greater interest in how IP is tracked, managed and deployed. A first step in the evolution of an improved understanding and management of this critical asset is a reliable CoC solution.

The present invention provides secure, cryptographic access to critical data about patents. The CoC solution enables the primary data to remain on a Hyperledger with selective, high-value information migrated and maintained on the public blockchain, enabling that patent data to be encrypted (all data is encrypted by default, but authors can choose to exclude certain fields from encryption so that it is open for public view), with decryption available only to the parties holding the encryption keys. In the case of patents, those parties are likely to be the patent holders themselves, any entities licensed to use the patent, and selective regulatory agencies if necessary.

The present invention also implements an integration infrastructure to create a Global Patent Registry (GPR) with the blockchain to support a consortium of Patent Owners, National Patent Offices, and Verifiers. GPR allows for the current process of granting, publishing, owning, transferring, and pledging patents onto the blockchain of the present invention, using smart contracts to manage these processes. GPR enables strong provenance capabilities, allowing for patents to be clearly traced as they are created, maintained, licensed, and transferred. The result is a more efficient, complete, equitable, globally compliant, and revenue-generating patent ecosystem that supports patent owners, licensers, granting authorities, and verifiers.

The present invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents.

Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Persons of ordinary skill in the art are able to understand that all or portions of the steps in the embodiments described above may be realized using programs instructing the relevant hardware, and said programs can be stored on computer-readable storage media, such as a read-only memory, hard disk or compact disc. Optionally, all or portions of the steps of the embodiments described above may also be realized using one or multiple integrated circuits. Accordingly, the various modules/units contained in the embodiments above may also be realized in the form of hardware or software function modules. Thus, the present application is not limited to any specific combination of hardware and software.

The present application may have a variety of other embodiments and, without departing from the spirit and substance of the present application, persons skilled in the art may produce a variety of corresponding changes and modifications based on the present application, but these corresponding changes and modifications shall all fall within the scope of protection of the claims of this application.

Although the foregoing embodiments have been described in some detail for purposes of clarity of understanding, the invention is not limited to the details provided. There are many alternative ways of implementing the invention. The disclosed embodiments are illustrative and not restrictive.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

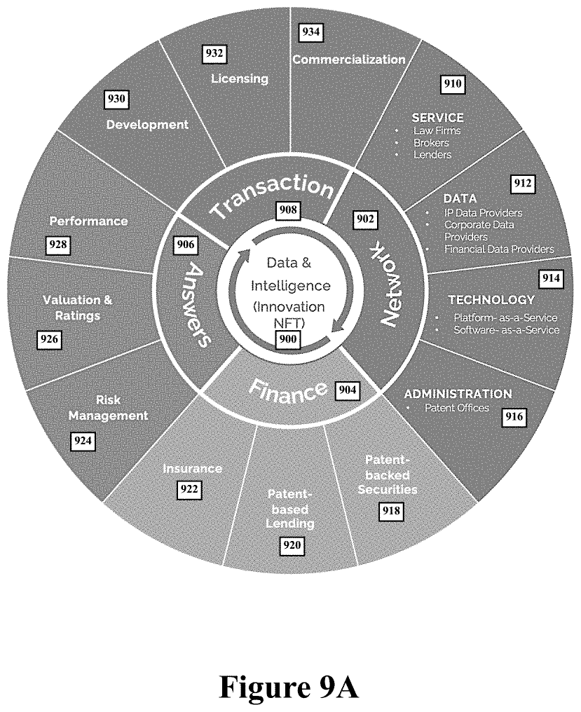

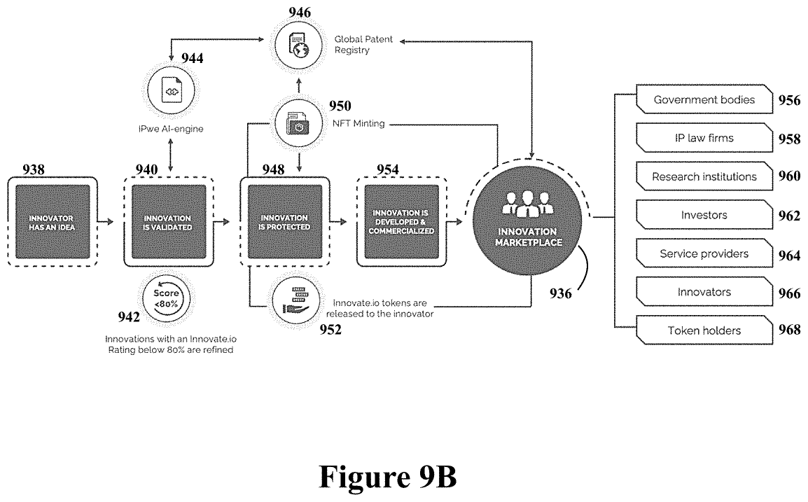

FIGS. 9A-B provide an overview of the platform of the present invention. As shown in FIG. 9A, the core of the present invention 900 is built around data and intelligence (such as the IPwe NFT). The structure then incorporates a network 902, finance 904, answers 906 and transactions 908. The network 902 includes: services (such as law firms, brokers and lenders) 910; data (such as IP, corporate and financial data) 912; technology (such as platform-as-a-service and software-as-a-service) 914; and administration (such as patent offices) 916. Finance 904 includes: patent backed securities 918; patent based lending 920; and insurance 922. Answers 906 include: risk management 924; valuation & ratings 926; and performance 928. Transactions 908 include: development 930; licensing 932; and commercialization 934. The present invention is a global decentralized innovation marketplace that is powered by proprietary AI and blockchain technologies.

FIG. 9B is a flow diagram of the platform of the present invention, which is also known as the innovation marketplace 936. When an innovator has an idea 938, the innovation can be validated 940 through the platform's algorithm-based score system 942, and through the platform's AI engine 944. The platform uses a range of tools to evaluate, refine and rate the Initial Description and subsequent iterations. The rating score relies on a validated rating methodology that leverages machine learning tools.

In harmony with the industry practice of transacting simple families rather than individual patent filings, the score algorithms use patent families as the most granular level of assessment for its ratings. A patent family is “a set of patents taken in various countries to protect a single invention”. Based on the harmonized view of WIPO, EPO, USPTO and CNIPA, a simple patent family is “the same invention [disclosed by common inventor(s) and] patented in more than one country.” Accordingly, an invention can be protected in more than one territory on the world's surface; the respective filings are linked structurally on the simple family level. Using the Global Industry Classification Standard used in the financial rating industry, the classification algorithm identifies one of 32 Industries, or patented technology areas. Only stacks of patents belonging to the same technology area are compared with each other. Conceptually, IPwe rates patent families that feature at least one granted patent in one of the top 5 patent jurisdictions.

Each invention has a total of 13 attributes structurally relevant for the rating. The attributes cover questions like validity prospects of the family, citations of the family, territorial span in meaningful jurisdictions for monetization, global filing trend lines, verification of title, and to some extent license and litigation records (if publicly available). The rating algorithm summarizes these attributes to an overall rating as the weighted average of the 13 rating attributes, normalized to make the ratings comparable. Innovators leverage these algorithms to refine their Initial Descriptions following advice provided by the rating engine directly or seeking help from service providers. Service providers also use these algorithms, not only cutting their costs and hence the costs they pass on to Innovators but providing them with new information and analytics that can support the emergence of completely new innovation services.

Once the innovation is validated, the present invention also implements an integration infrastructure to create a Global Patent Registry (GPR) 946 with the blockchain to support a consortium of Patent Owners, National Patent Offices, and Verifiers. GPR allows for the current process of granting, publishing, owning, transferring, and pledging patents onto the blockchain of the present invention, using smart contracts to manage these processes. GPR enables strong provenance capabilities, allowing for patents to be clearly traced as they are created, maintained, licensed, and transferred. The result is a more efficient, complete, equitable, globally compliant, and revenue-generating patent ecosystem that supports patent owners, licensers, granting authorities, and verifiers.

In accordance with the preferred embodiment, the platform, NFTs, and IP rights, can be generated as soon as an Innovator wants to share an Initial Description of an innovation, independently of its score. The innovation is protected 948 and minted 950 into an NFT containing a pointer to an IPFS URL where the encrypted Initial Description is stored. This NFT will be used as a reference point for smart contracts that organize the relationships between the Innovator and others. The platform then releases the innovation tokens to the innovator 952, and the innovation is developed and commercialized 954.

The innovation marketplace platform 936 of the present invention also facilitates interaction between the innovator and multiple different types of stakeholders, including government bodies 956; IP law firms 958; research institutions 960; service Providers 964; and any other type of person/entity providing services regarding the establishment, development, and refinement of innovation. The Innovator can also interact with investors 962 who are seeking earlier stage opportunities where outsized social and financial returns typically reside, and other innovators 966 who contribute to the platform with innovative ideas and seek services, financing or expertise from other platform stakeholders or token holders 968 to bring innovations to life.

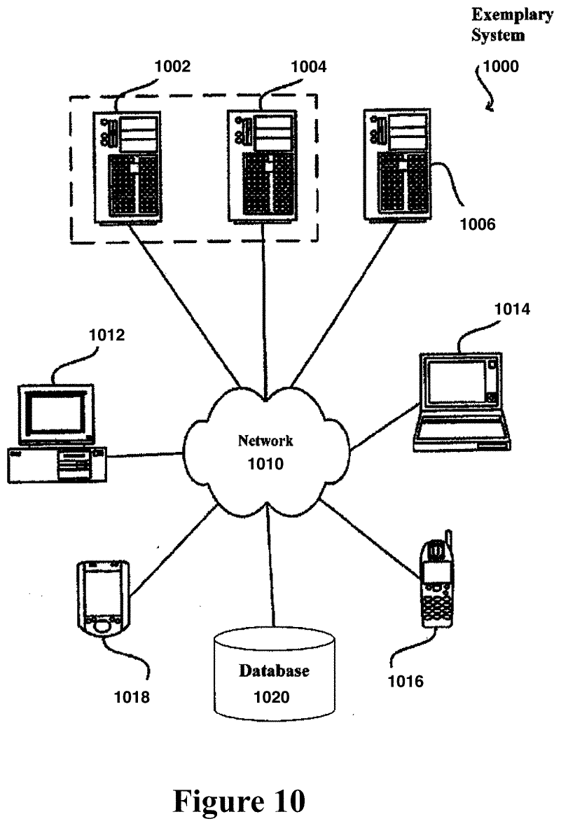

FIG. 10 is a block diagram illustrating components of an exemplary operating environment in which embodiments of the present invention may be implemented. The system 1000 can include one or more user computers, computing devices, or processing devices 1012, 1014, 1016, 1018, which can be used to operate a client, such as a dedicated application, web browser, etc. The user computers 1012, 1014, 1016, 1018 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 1012, 1014, 1016, 1018 may also have any of a variety of applications, including one or more development systems, database client and/or server applications, and Web browser applications. Alternatively, the user computers 1012, 1014, 1016, 1018 may be any other electronic device, such as a thin-client computer, Internet-enabled gaming system, and/or personal messaging device, capable of communicating via a network (e.g., the network 1010 described below) and/or displaying and navigating Web pages or other types of electronic documents. Although the exemplary system 1000 is shown with four user computers, any number of user computers may be supported.

In most embodiments, the system 1000 includes some type of network 1010. The network can be any type of network familiar to those skilled in the art that can support data communications using any of a variety of commercially-available protocols, including without limitation TCP/IP, SNA, IPX, AppleTalk, and the like. Merely by way of example, the network 1010 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 1002, 1004, 1006 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 1006) may be dedicated to running applications, such as a business application, a Web server, application server, etc. Such servers may be used to process requests from user computers 1012, 1014, 1016, 1018. The applications can also include any number of applications for controlling access to resources of the servers 1002, 1004, 1006.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 1012, 1014, 1016, 1018. As one example, a server may execute one or more Web applications. The Web application may be implemented as one or more scripts or programs written in any programming language, such as Java®, C, C # or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 1012, 1014, 1016, 1018.

The system 1000 may also include one or more databases 1020. The database(s) 1020 may reside in a variety of locations. By way of example, a database 620 may reside on a storage medium local to (and/or resident in) one or more of the computers 1002, 1004, 1006, 1012, 1014, 1016, 1018. Alternatively, it may be remote from any or all of the computers 1002, 1004, 1006, 1012, 1014, 1016, 1018, and/or in communication (e.g., via the network 1010) with one or more of these. In a particular set of embodiments, the database 1020 may reside in a storage-area network (“SAN”) familiar to those skilled in the art. Similarly, any necessary files for performing the functions attributed to the computers 1002, 1004, 1006, 1012, 1014, 1016, 1018 may be stored locally on the respective computer and/or remotely, as appropriate. In one set of embodiments, the database 1020 may be a relational database, such as Oracle 10 g, that is adapted to store, update, and retrieve data in response to SQL-formatted commands.

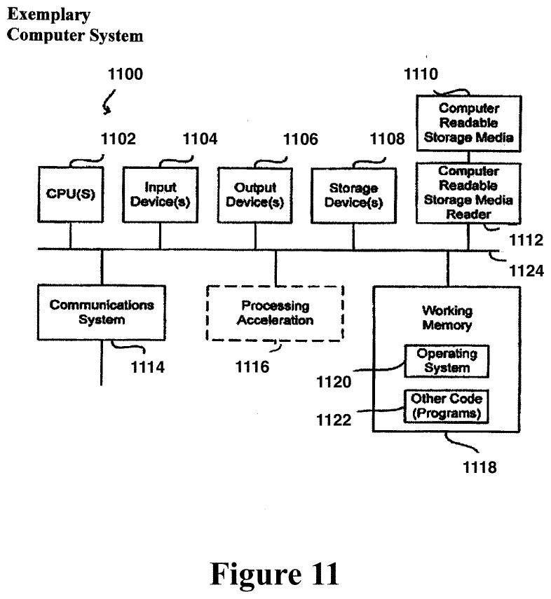

FIG. 11 illustrates an exemplary computer system 1100, in which embodiments of the present invention may be implemented. The system 1100 may be used to implement any of the computer systems described above. The computer system 1100 is shown comprising hardware elements that may be electrically coupled via a bus 1124. The hardware elements may include one or more central processing units (CPUs) 1102, one or more input devices 1104 (e.g., a mouse, a keyboard, etc.), and one or more output devices 1106 (e.g., a display device, a printer, etc.). The computer system 1100 may also include one or more storage devices 1108. By way of example, the storage device(s) 1108 can include devices such as disk drives, optical storage devices, solid-state storage device such as a random access memory (“RAM”) and/or a read-only memory (“ROM”), which can be programmable, flash-updateable and/or the like.

The computer system 1100 may additionally include a computer-readable storage media reader 1112, a communications system 1114 (e.g., a modem, a network card (wireless or wired), an infra-red communication device, etc.), and working memory 1118, which may include RAM and ROM devices as described above. In some embodiments, the computer system 1100 may also include a processing acceleration unit 1116, which can include a digital signal processor DSP, a special-purpose processor, and/or the like.

The computer-readable storage media reader 1112 can further be connected to a computer-readable storage medium 1110, together (and, optionally, in combination with storage device(s) 1108) comprehensively representing remote, local, fixed, and/or removable storage devices plus storage media for temporarily and/or more permanently containing, storing, transmitting, and retrieving computer-readable information. The communications system 1114 may permit data to be exchanged with the network and/or any other computer described above with respect to the system 1100.

The computer system 1100 may also comprise software elements, shown as being currently located within a working memory 1118, including an operating system 1120 and/or other code 1122, such as an application program (which may be a client application, Web browser, mid-tier application, RDBMS, etc.). It should be appreciated that alternate embodiments of a computer system 1100 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 11 further illustrates an environment where an on-demand distributed database service might be used. As illustrated in FIG. 11 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium® processor or the like. Similarly, a computer system (and additional instances of an enterprise database, where more than one is present) and all of their components might be operator configurable using application(s) including computer code run using a central processing unit such as an Intel Pentium® processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™ is a trademark of Sun Microsystems, Inc.).

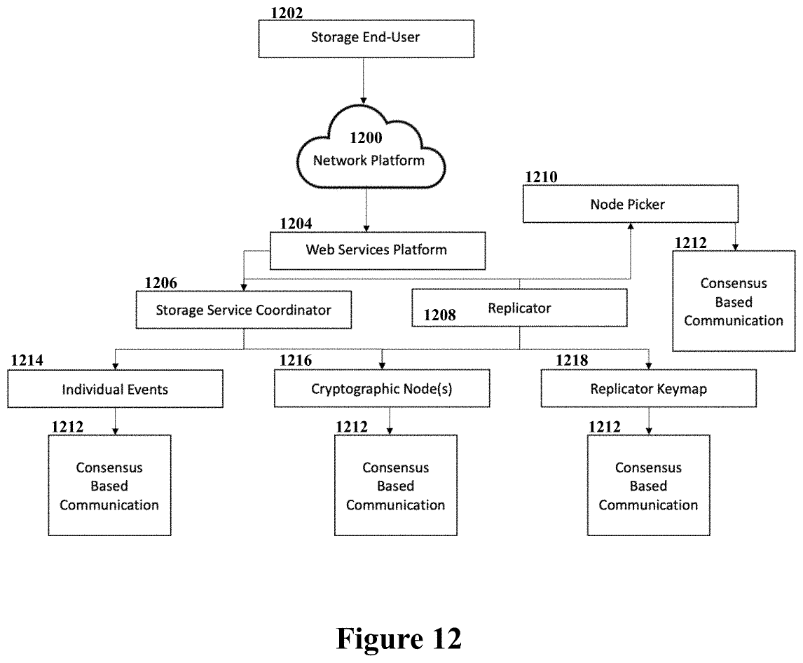

FIG. 12 is a diagram showing the communication between the storage end users 1202, the network platform 1200 and the various elements that help effectuate operations. The storage end user 1202 communicates and relays various pertinent bits of data to the network platform 1200. The network platform 1200 operates on the web service platform 1204, which features a storage service coordinator 1206 and replicator 1208. Each of these services utilize a node picker 1210 which helps establish consensus-based communication 1212. The storage service coordinator 1206 maintains and records individual events 1214 and cryptographic nodes 1216, or keys that are used for operations. The replicator has its own keymap 1218 which generates consensus-based communication 1212, alongside the cryptographic nodes 1216 and individual events 1214.

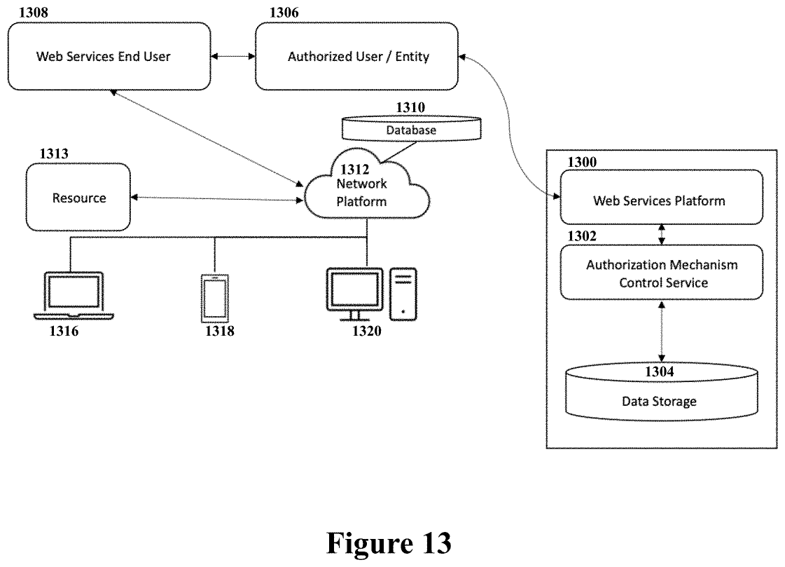

FIG. 13 is a diagram showing the web services of the platform and system. The platform and system are all components of an exemplary operating environment in which embodiments of the present invention may be implemented. The system can include one or more user computers, computing devices, or processing devices which can be used to operate a client, such as a dedicated application, web browser, etc. The user computers can be general purpose personal computers (including, merely by way of example, personal computers and/or laptop computers 1316 running a standard operating system), cell phones or PDAs 1318 (running mobile software and being Internet, e-mail, SMS, Blackberry, or other communication protocol enabled), and/or workstation computers 1320 running any of a variety of commercially-available UNIX or UNIX-like operating systems (including without limitation, the variety of GNU/Linux operating systems). These user computers may also have any of a variety of applications, including one or more development systems, database client and/or server applications, and Web browser applications. Alternatively, the user computers may be any other electronic device, such as a thin-client computer, Internet-enabled gaming system, and/or personal messaging device, capable of communicating via a network (e.g., the network described below) and/or displaying and navigating Web pages or other types of electronic documents. Although the exemplary system is shown with four user computers, any number of user computers may be supported.

In most embodiments, the system includes some type of network. The network can be any type of network familiar to those skilled in the art that can support data communications using any of a variety of commercially-available protocols, including without limitation TCP/IP, SNA, IPX, AppleTalk, and the like. Merely by way of example, the network can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, WiMAX, WiFi, CDMA 2000, WCDMA, the Bluetooth protocol known in the art, and/or any other wireless protocol); and/or any combination of these and/or other networks.

The system may also include one or more server computers which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers may be dedicated to running applications, such as a business application, a Web server, application server, etc. Such servers may be used to process requests from user computers. The applications can also include any number of applications for controlling access to resources 1314 of the servers.

The web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers. As one example, a server may execute one or more Web applications. The Web application may be implemented as one or more scripts or programs written in any programming language, such as Java®, C, C #, or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer.

End users 1308, or users that are viewing and using the network platform 1312, all contribute data to the cloud. A web service platform 1300 helps secure that data and maintain the service's functionalities. Only authorized users and entities 1306 can authorize or unauthorize content and monitor data stored within the web service. The platform's web services 1300 help maintain the operations of elements through the authorization mechanism control service 1302 managed by the data storage system 1304.

The system may also include one or more databases 1310. The database(s) 1310 may reside in a variety of locations. By way of example, a database 1310 may reside on a storage medium local to (and/or resident in) one or more of the computers 1320. Alternatively, it may be remote from any or all of the computers, and/or in communication (e.g., via the network) with one or more of these. In a particular set of embodiments, the database may reside in a storage-area network (“SAN”) familiar to those skilled in the art. Similarly, any necessary files for performing the functions attributed to the computers may be stored locally on the respective computer and/or remotely, as appropriate. In one set of embodiments, the database may be a relational database, such as Oracle 10 g, that is adapted to store, update, and retrieve data in response to SQL-formatted commands.

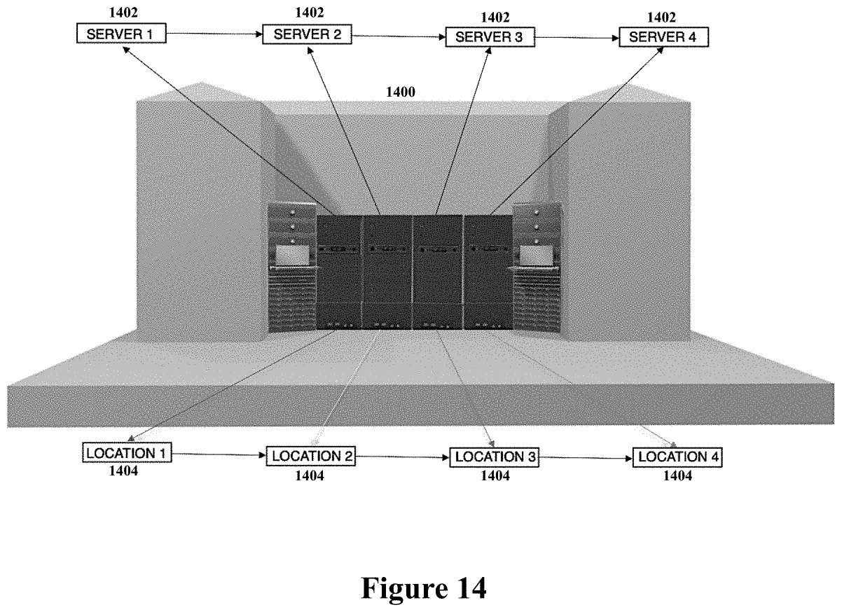

FIG. 14 is an illustration of server-to-server connections 1402, within a server room 1400 and to other sever room locations 1404. The web server undergoes an initialization process and features a database of wireless network data. Dependent on the service requested, the data may undergo processing. The servers 1402 actively attempt to retrieve the appropriate data to provide user input. Data may then be formatted, and with the appropriate authorizations, saved or restructured.

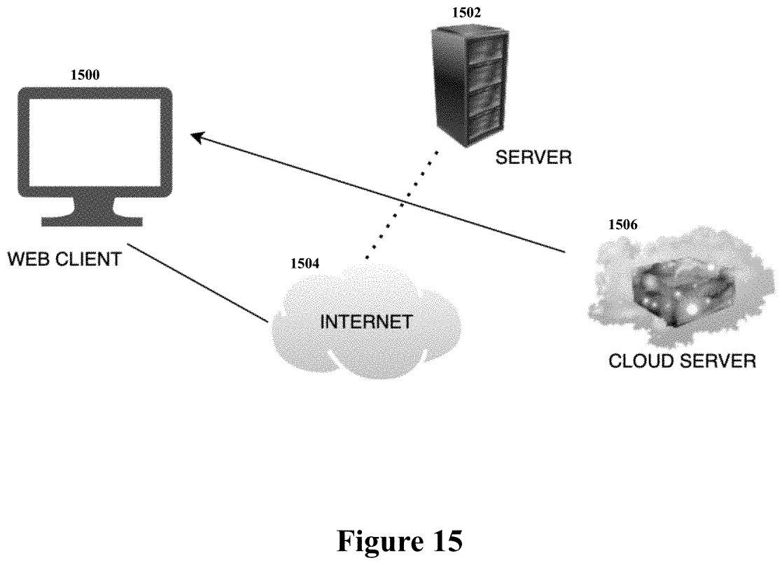

FIG. 15 is a diagram outlining the role of web services in the present invention. In accordance with the preferred embodiment, a web client 1500 interacts with the server ecosystem 1502 by way of a service connection, such as the internet 1504, which then distributes data and pertinent information such as the web service platform to the cloud server 1506 and preliminary servers. This allows for data to be streamlined between the client 1500 and the server 1502 as well as cloud servers 1506 and other database systems. Communication between web services may be completed via Simple Object Access Protocol (SOAP) which allows multiple web service applications to communicate rapidly and efficiently and to provide data to the web client.

The infrastructure of the present invention also allows for the use of web services that enable interaction with and storage of data across devices. Specifically, these web services can allow for the use of cloud software tools and cloud-based data storage. Cloud software tools can be used to allow for increased user authentication and authorization checkpoints for data accessed between parties. The web service software aids in the transmission of data between entities while still maintaining secure access restrictions preventing any unauthorized access to the cloud data.

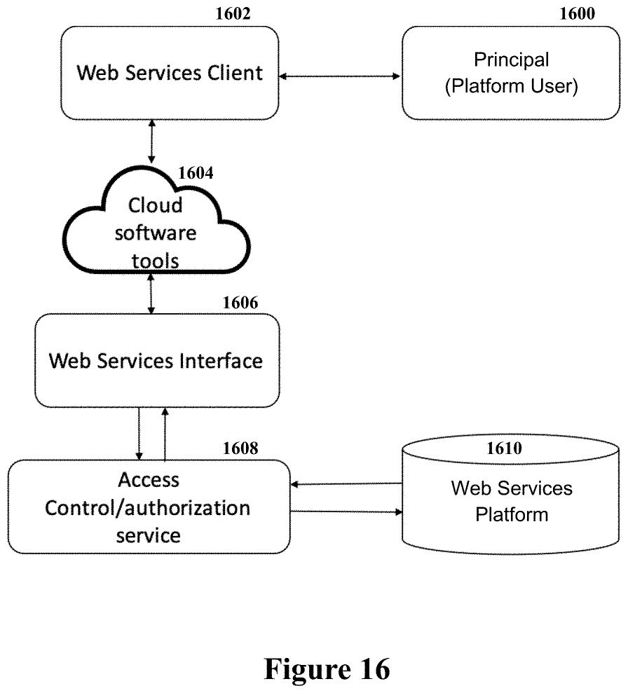

FIG. 16 is a diagram of the flow of access between the platform of the present invention and the web services client via cloud software tools. The principal or platform user 1600 accesses the web services client 1602, which then transmits data via cloud software tools 1604 to the web services interface 1606. Access control and authorization 1608 acts as a layer in order to access the web services platform 1610 by way of the web services interface 1606.

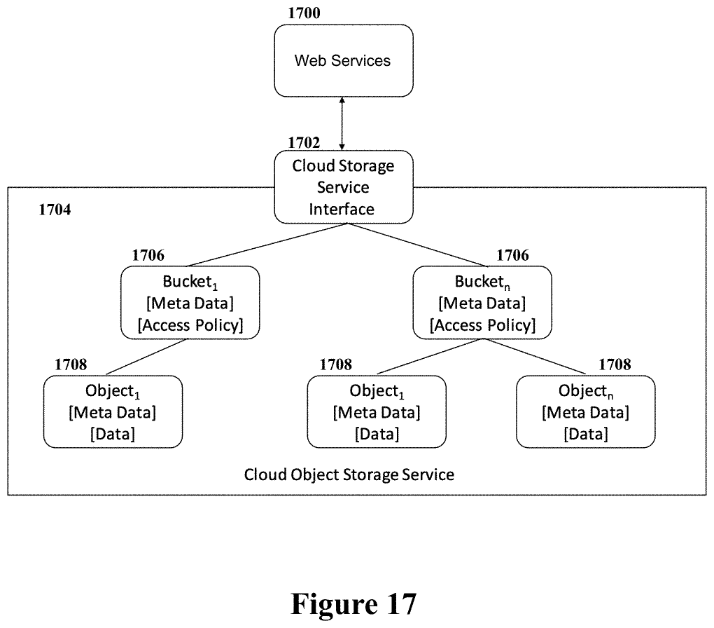

FIG. 17 is a diagram of an example of the cloud storage organization in which the web services 1700 accesses and retrieves user data as objects 1708 in buckets 1706 within a cloud storage space 1704. The cloud storage 1704 service is a means of storing and protecting any amount of data for a range of use cases. A bucket 1706 is a container for objects stored in the cloud storage service 1704, and objects 1708 consist of object data and metadata. The metadata is a set of name-value pairs that describe the object. These pairs include some default metadata, such as the date last modified, and standard HTTP metadata, such as Content-Type. You can also specify custom metadata at the time that the object is stored. Web services 1700 provide access to and from the cloud object storage service 1704 via the cloud storage service interface 1702.

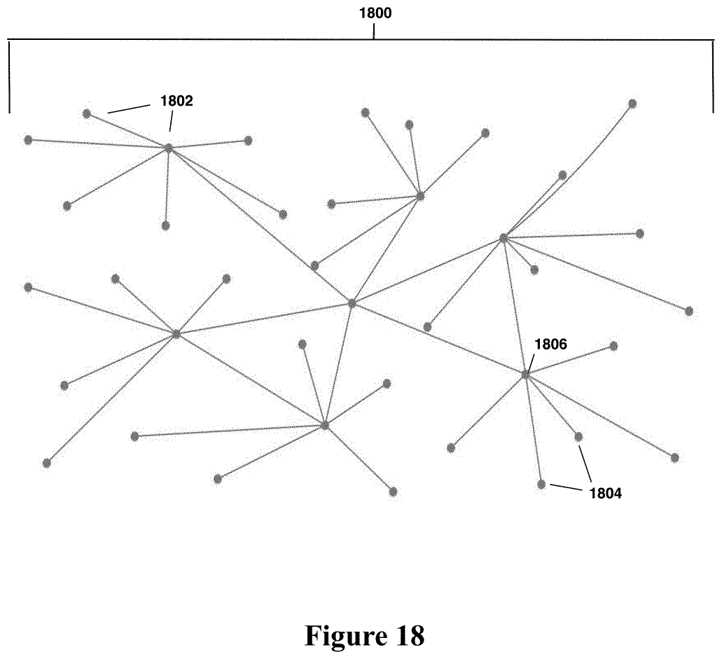

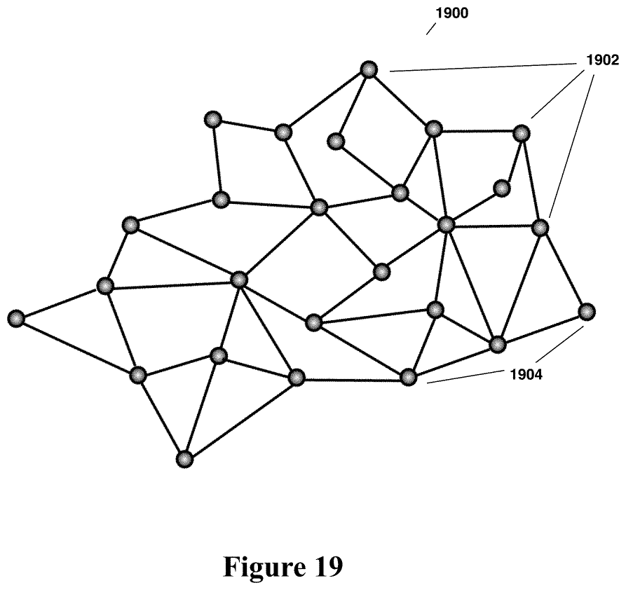

FIG. 18 is a line diagram illustrating a decentralized network. In accordance with the preferred embodiment of the present invention, the specific architecture of the network can be either decentralized or distributed. FIG. 18, generally represented by the numeral 1800, provides an illustrative diagram of the decentralized network. FIG. 18 depicts each node with a dot 1802 Under this system, each node is connected to at least one other node 1804. Only some nodes are connected to more than one node 1806.

FIG. 19 is a line diagram illustrating a distributed network. For comparison purposes, FIG. 19, which is generally represented by the numeral 1900, illustrates a distributed network. Specifically, the illustration shows the interconnection of each node 1902 in a distributed decentralized network 1900. In accordance with the preferred embodiment of the present invention, each node 1902 in the distributed network 1900 is directly connected to at least two other nodes 1904. This allows each node 1902 to transact with at least one other node 1902 in the network. The present invention can be deployed on a centralized, decentralized, or distributed network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

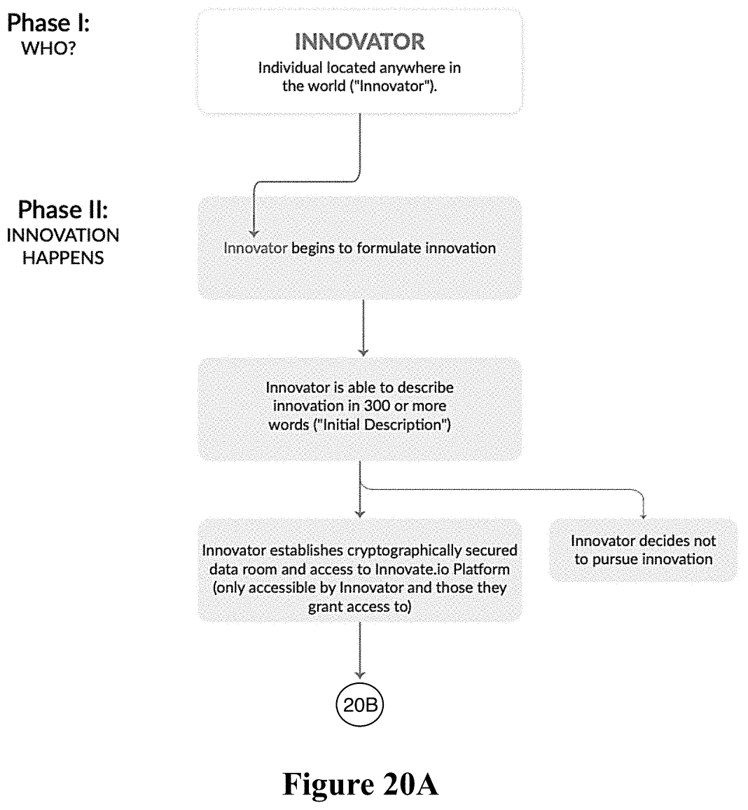

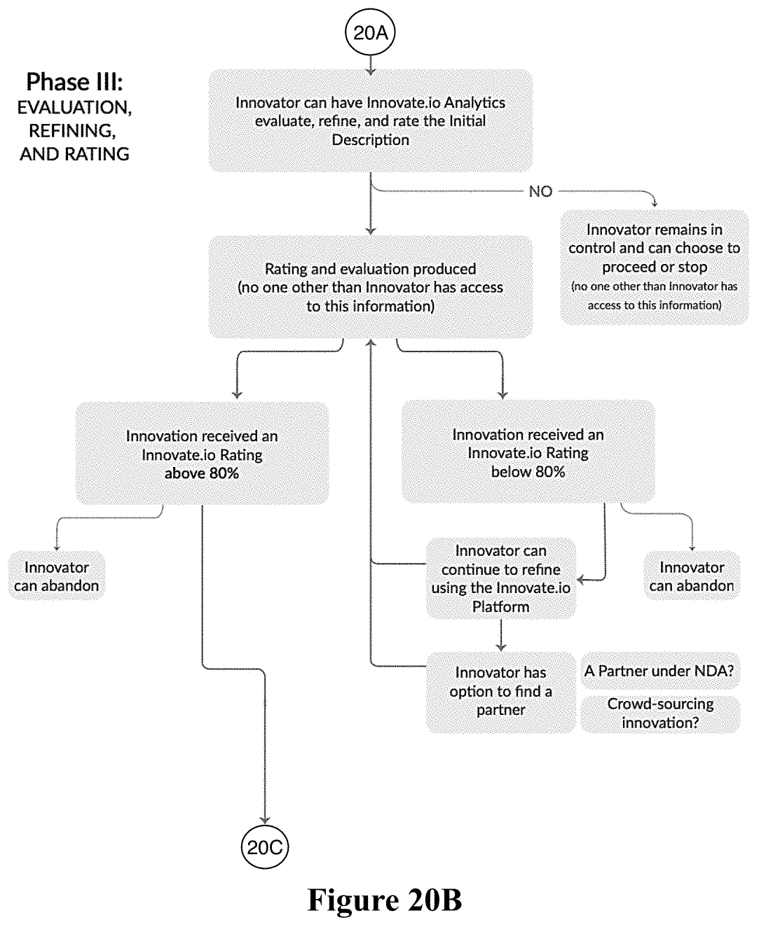

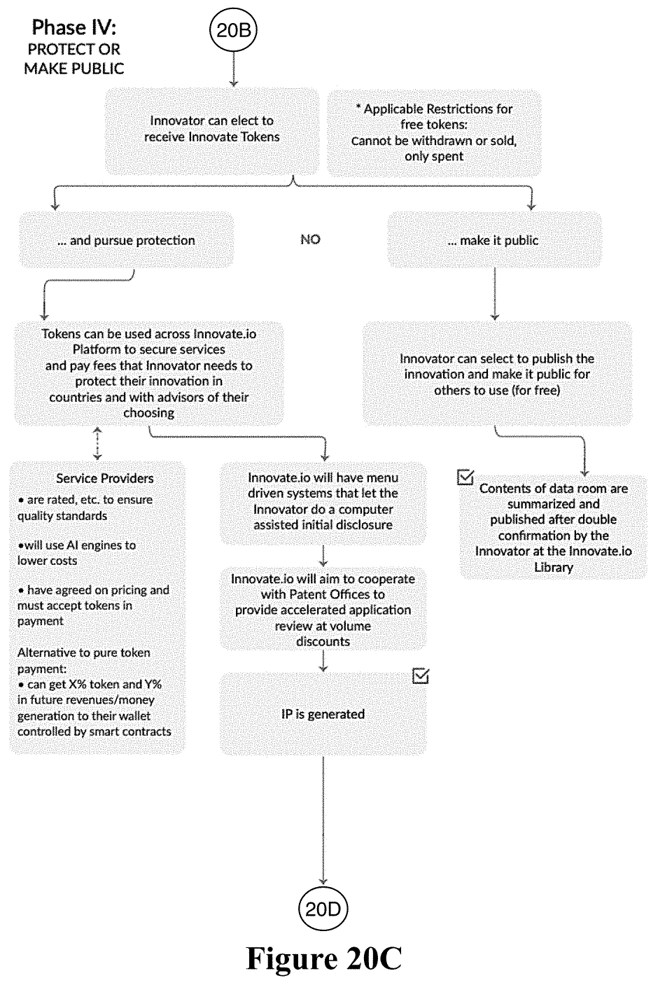

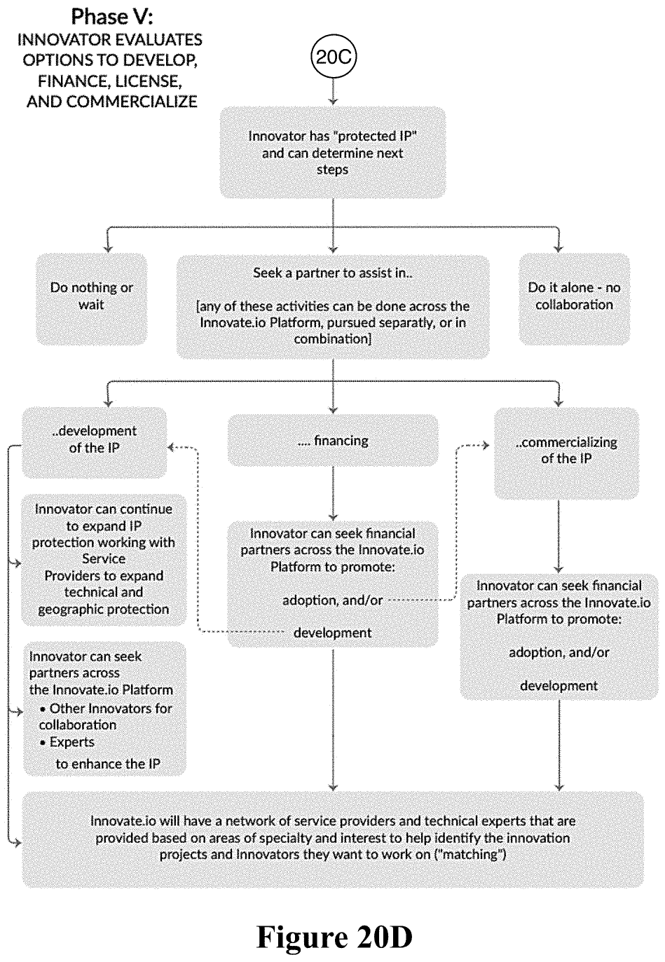

FIGS. 20A-D are flow diagrams of the process of the present invention. In accordance with the preferred embodiment of the present invention, the innovation process on Innovate.io is designed to comprise five phases. A menu-driven system with a simple, clean UI guide that leads users through the innovation process with explanatory video tutorials, and detailed FAQs, providing individualized advice to the user to achieve the user goals in a fast and efficient manner. Through engagement with the community, the Platform is continuously updated and improved.

FIG. 20A is a flow diagram of Phase I and Phase II of the present invention. Phase I is centered around the Innovator, who can be an individual or a group of individuals located anywhere in the world. The Innovate.io Platform is the nurturing ground for the Innovator's ideas to be brought to fruition and to prosper. Platform engagement is made simple to encourage innovators, service providers, partners and others to utilize the Innovate.io Platform.

In Phase II, the innovation process starts. The Innovator begins to formulate the innovation until the Innovator can describe the innovation in 300 or more words. When this level is reached and the “Initial Description” is available, the innovation is transitioned from the physical world to the Innovate.io Platform to be advanced and supported. The quantitative threshold of 300 words of the Initial Description is required to ensure that a minimum body of text is available for AI tools to execute on and evaluate reliably. Based on our experience in the space, the 300-word minimum safeguards reliable results. Before any data is uploaded by the Innovator, a Non-Disclosure Agreement (NDA) is signed as a digital contract on the Innovate.io Platform to make it absolutely clear that information disclosed by the Innovator is not deemed disclosed to anyone (which can be detrimental to patent filings). With the conclusion of the NDA, a cryptographically secured data room is established. The secure data room is only accessible by the Innovator and those the Innovator grants access to. Anyone accessing the data room is mandatorily required to become a party to the NDA. The access times, session durations, and IP addresses per person, and the terms of the NDA are recorded on-chain to create a trail of evidence preventing abuse (e.g., theft of ideas). During Phase II, the Innovator can use the Platform to improve the Initial Disclosure. This can be accomplished using AI tools that are accessible free of charge by innovators or even through engagement with service providers and partners.

FIG. 20B is a flow diagram of Phase III of the present invention. In Phase III, the Innovator can decide to have the Initial Description rated. The goal of Phase III is to have a rating and a corresponding evaluation computed for the (preferably refined) Initial Description. The rating is expressed as a score from 0-100%. A rating score of above 80% allows the Innovator to enter Phase IV. A lower score incentivizes the Innovator to refine the Initial Description documentation either alone, or if they choose, with the help of a service provider or partner using the Innovate.io Platform.

The Innovate.io Platform has licensed a range of exponential tools to evaluate, refine and rate the Initial Description. Recommendations and explanations as to why a specific result was returned and how it can be improved are provided in every step along the way. The rating score relies on a broadly validated rating methodology that has provided convincing results in the past. Typically, wheat is separated from the chaff using a threshold of 75%, therefore, the threshold of 80% thus ensures that the innovations brought before the rating algorithm are sufficiently matured (both regarding their substance and their description/documentation). The cryptographically secured data room ensures that no third party has access to the innovation documentation and/or the ratings. Accordingly, rating scores below 80% are not discoverable by third parties and therefore not harmful to the Innovator. Low scores can be refined by following the advice provided by the rating engine, or together with a service provider or partner (under NDA), where the problem that the Innovator intends to solve would be decomposed into individual tasks, at which point, Platform users can provide independent and partial recommendations or solutions that are integrated by the Innovator. If the Innovator wants to team up with a partner with an Initial Description below 80%, the Initial Description is minted into an NFT (with secret content as the metadata document that points to an IPFS URL where the encrypted Initial Description is stored) to be a reference point for smart contracts that organize the internal relationship between the Innovator and others. As third-party services at this stage are not necessarily free, the Innovator may be required to purchase Innovate Tokens (as the free token grant has not occurred yet, see Phase IV as shown in FIG. 20C) or to contractually promise future revenue allocation to the supporting third party.

FIG. 20C is a flow diagram of Phase IV of the present invention. In Phase IV, the Innovator (owning an innovation whose Initial Description has obtained a rating of 80%+) can elect to receive free Innovate Tokens. This free token grant supports the Innovators of high-potential innovations to pursue one of two paths: acquire IP protection or publish the innovation for open access use. Both use cases benefit society and are accordingly rewarded by the Innovate.io Platform. If the Innovator wants to pursue the road to IP protection, the Innovate Tokens can be spent on the services of Service Providers accredited to the Innovate.io Platform to bring the Initial Disclosure to its full potential and yield the best IP possible.

When the Innovator opts to receive free tokens, the innovation is tokenized and stored in an NFT as a reference object for both the token grant agreement and services. The free token grant is not completely unrestricted to avoid that the Innovator claiming the free tokens does not sell them for profit and abandon the innovation secretly. The trading restrictions of the Innovate Tokens can be lifted automatically by the system, e.g., if the innovator decides to publish the innovation. In this case, the contents of the data room are summarized and published after double confirmation by the Innovator in a publicly accessible online repository called the Innovate.io Library. Such a Library has the potential to become one of mankind's most interesting sources of creativity and open-access innovation to tackle challenges like overpopulation, world hunger, and climate change. Once the innovation is published, the Innovator may sell off the Innovate Tokens that were initially awarded for free.

In the alternative, the Innovator can pursue the proprietary IP protection road. The Innovate Tokens can be used across the Innovate.io Platform to secure services and pay fees that the Innovators need to protect their innovation in countries and with advisors of their choosing. To facilitate access and to ensure quality standards, the Service Providers are rated. The ratings are continuously updated based on the most recent work products. To ensure low fees, the Service Providers receive access to AI engines to keep costs low. Also, Innovate.io will aim to cooperate with Patent Offices to provide accelerated application reviews at volume discounts. All Service Providers will have agreed on pricing and must accept Innovate Tokens as payment. Once the Service Providers are paid, the Innovate Tokens that changed hands can be sold on the Innovate.io Platform to convert them into other currencies. As an alternative to pure token payments, the Innovators can opt to pledge future revenues generated with the protected IP. Smart contracts safeguard that these pledges (which are recorded in the NFT itself) cannot be ignored or circumvented in the future. Accordingly, the Service Providers can recover the expenses with a profit margin in the future. If the Innovator uses the latter payment model, the Innovate Tokens that were initially awarded for free can be sold without restriction as soon as a patent application is filed.

FIG. 20D is a flow diagram of Phase V of the present invention. Phase V can only be reached once an Innovator has filed for a patent anywhere in the world. It is an optional phase that offers to connect Partners to the Innovator to further develop innovation, find financial backing, or to commercialize the (pending or granted) IP. To make this process as efficient as possible, Innovate.io will match Innovators to Partners based on the relevant project attributes and needs. Technically, the Phase V services by partners are all related to the Innovation NFT or patent applications derived from the Innovation NFT. Using smart contracts, an array of extremely helpful services can be offered to maximize the yield from the innovation or to open new paths that a single innovator would not have been able to pursue in the past, e.g., productization of the innovation.

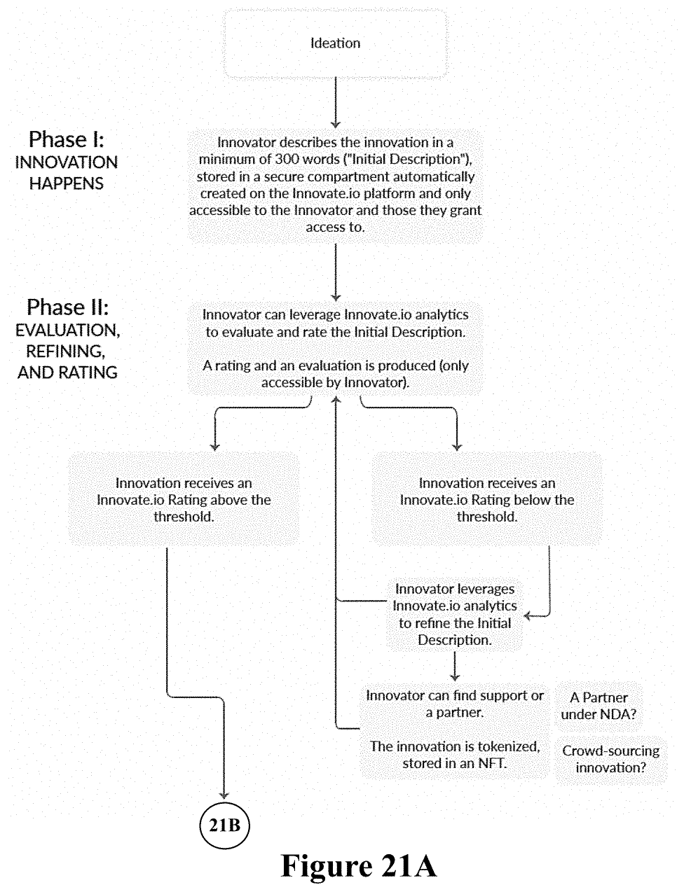

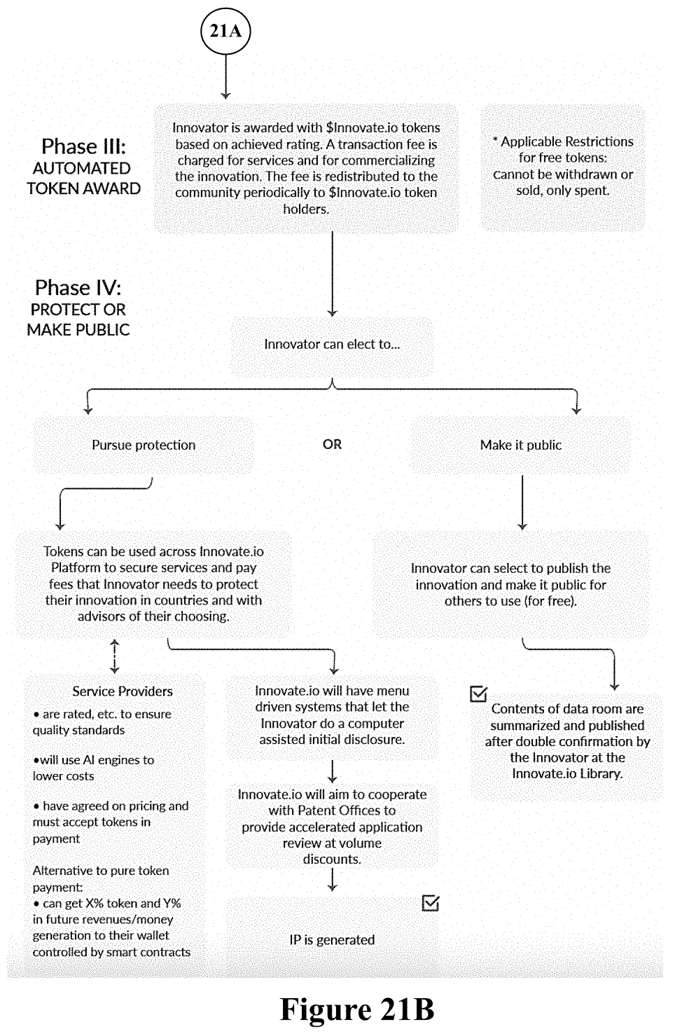

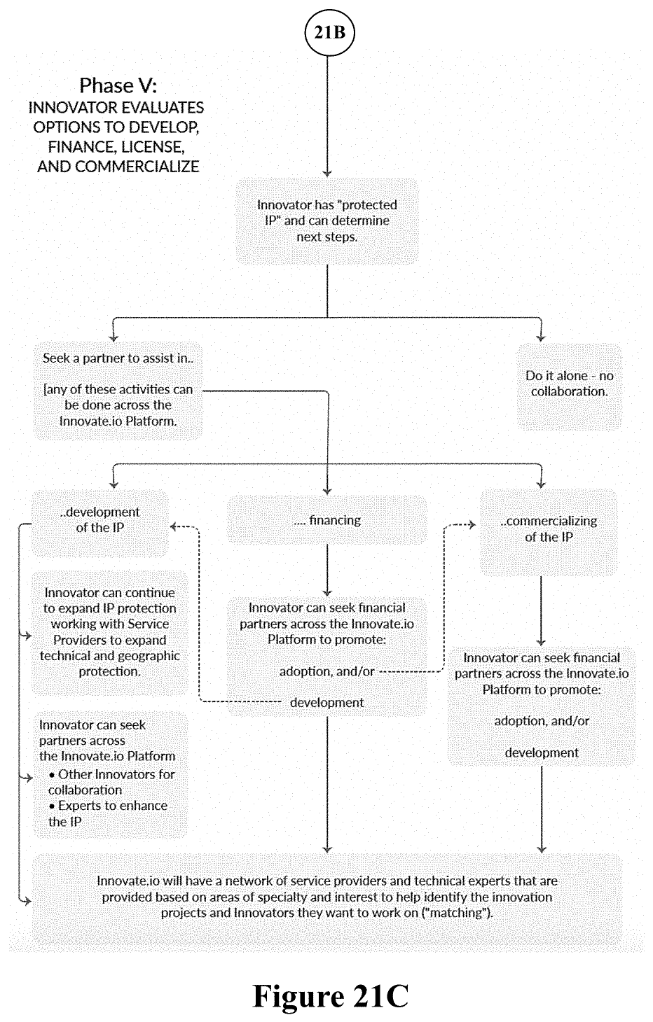

FIGS. 21A-C are flow diagrams of the process of the present invention. In accordance with the preferred embodiment of the present invention, the innovation process on Innovate.io is designed to comprise five phases. The innovation process that gathers these stakeholders on the Innovate.io platform consists in five phases. Throughout the process the Innovator remains in control and can abandon at any stage or postpone their engagement.

As shown in FIG. 21A, Phase I of the process of the present invention is the initial description of the innovation. Before any data is shared by an Innovator, a Non-Disclosure Agreement (NDA) is signed as a digital contract stored on the Innovate.io platform to protect the Innovator. A secure compartment is then created for the Innovator to describe his or her innovative idea. There, the Innovator describes the innovation in 300 words minimum; this threshold is required for AI algorithms to evaluate the innovation reliably.

As shown in FIG. 21A, Phase II of the process of the present invention is the evaluation, refining and rating the innovation. Next, the Innovator is awarded a rating and a corresponding evaluation computed for the Initial Description by the Innovate AI engine. A rating score above the threshold allows the Innovator to move on to the next phase. A score below that, incentivizes the Innovator to refine the Initial Description either alone, or with the help of others directly within the Innovate.io platform. Recommendations and explanations as to why a specific score was obtained and how it can be improved are provided to the Innovator. This evaluation is available in multiple languages and the system assists and helps guide the innovator to enhance and improve their ideas.

As shown in FIG. 21B, Phase III of the process of the present invention is the $innovate token award for important innovations. Once the innovation receives a rating above a threshold level, the innovator is awarded $innovate tokens—the higher the rating, the more $innovate tokens are rewarded. The innovator can then use these $innovate tokens to enhance, finance and commercialize their innovation using the Innovate.io platform. The idea is a simple one—the innovator is rewarded for creating important innovations. The innovator then decides how best to capture the benefit of that innovation without concern for financial, regulatory or other resource constraints. Before the $innovate tokens are accepted, the innovator enters into a smart contract with Innovate.io and agrees that Innovate.io receives a percentage ranging from 2.5 to 5% of all future economic returns generated by the innovation. These returns are then captured by the Innovate.io platform and periodically paid as dividends to the holders of $innovate tokens.

As shown in FIG. 21B, Phase IV of the process of the present invention is the process to protect or make public. Once the innovation receives a rating above the threshold level and the $innovate tokens are awarded, the Innovator decides whether to make the Initial Description a public good, in which case it will go into the Innovate.io Library (more on this below) or to pursue protection for that innovation. An innovator that makes their innovation public contributes to the public good and can still work with others using the Innovate.io platform and $innovate tokens to develop and promote that innovation. An innovator that decides to pursue protection will be able to use their $innovate tokens to work with governmental agencies, experts and lawyers to protect their innovation at no additional cost to them. Most often this will take the form of a patent, but there may be other protections that the innovator also determines to utilize. Innovators innovate and the Innovate.io platform and network serves the innovator to keep them focused on innovation. After pursuing protection of their innovation, innovators remain in full control to modify the terms. For example, it is possible to make the protected innovation available on terms that are free for all, or under certain conditions e.g., all improvements made available free of charge, or any other terms set by the innovator.

As shown in FIG. 21C, Phase V of the process of the present invention is to develop, finance, license and commercialize the innovation. Once an Innovator has decided to protect their innovation and filed for a patent somewhere in the world, an array of services is offered via the Innovate.io platform to enhance, finance and productize the innovation and hereby maximize the yield from the latter, opening new paths that a single innovator would not have been able to pursue. At any time during this stage, the Innovator is free to negotiate additional commercial terms with third parties the innovator deems important to the development of the innovation.

These additional commercial terms will be implemented through smart contracts and be transparent to the innovator and any others with an interest in the innovation, which will encourage fair and transparent pricing and more efficient negotiation. Experts, investors, commercial partners and others the innovator deems important to the licensing and commercialization efforts can all be accessed on transparent terms over the Innovate.io platform and implemented using Innovate.io smart contracts.

As that has been awarded $innovate tokens are licensed or commercialized a portion of the economic return (ranging from 2 to 5%) is captured by the Innovate.io platform and periodically paid to the holders of the $innovate token. This dividend can then be used by the $innovate token holder as they see fit, including to invest in additional innovation or to otherwise capture as return to reinvest in other endeavors. These five phases materialize on the Innovate.io web platform, which is underpinned by a token, an NFT marketplace and a library, and a set of artificial intelligence algorithms.

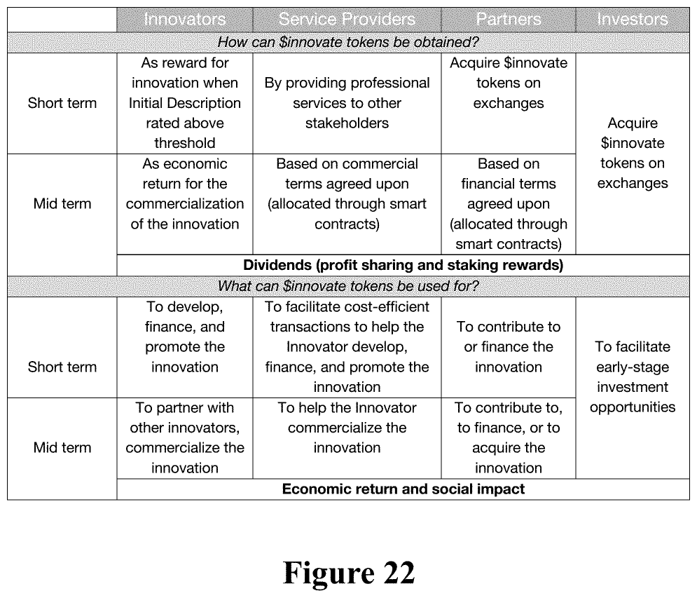

FIG. 22 is a diagram of the token uses for each stakeholder of the present invention. In accordance with the preferred embodiment of the present invention, the $Innovate token is, an ERC-20 token, built on a decentralized finance (DeFi) architecture that can be found in appendix. Each stakeholder may obtain and use $Innovate tokens differently as shown in FIG. 22. Overall, the $Innovate token has 3 use-cases: A utility token to reward Innovators who disclose their innovations within the Innovate.io platform; the higher the score their idea gets, the more $Innovate tokens they are rewarded. A currency that platform stakeholders use to transact with one another. For instance, Innovators pay Service Providers using the $Innovate token to protect, develop, promote, publish, finance or commercialize the innovation in the countries of their choosing; Partners can pay Innovators in $Innovate tokens to use licensed intellectual property. A staking mechanism that pays dividends to those who hold on $Innovate tokens.

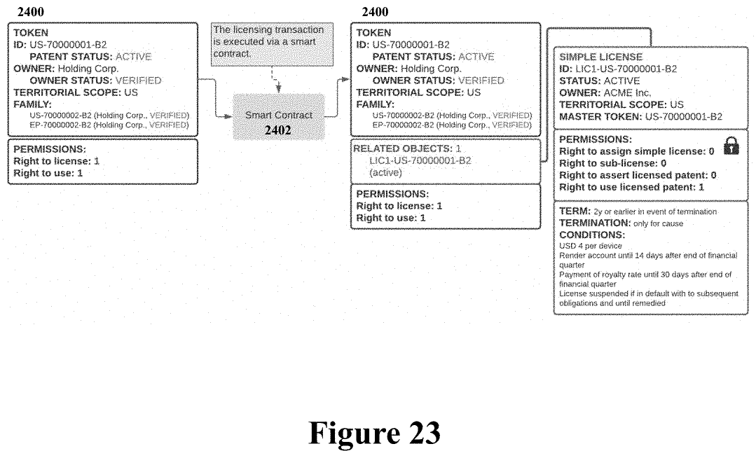

FIG. 23 is a flow diagram showing the NFT interaction with smart contracts of the present invention. In accordance with the preferred embodiment of the present invention, Intellectual property (IP) “refers to creations of the mind, such as inventions; literary and artistic works; designs; and symbols, names and images used in commerce”. IP rights can be in the form of patents, copyright, trademarks, industrial designs, geographical indications and trade secrets. IP rights enable innovators to earn recognition or financial benefit from their creation and exclude others from making, using, or selling an invention or innovation in a specific territory. In the Innovate.io platform, ownership rights of IP are represented as non-fungible tokens (NFTs) 2300.

NFTs 2300 are unique, non-interchangeable digital assets recorded on the blockchain. Properties inherent to blockchain technology and NFTs, such as immutability, transparency, trust, decentralization and traceability, strongly benefit the innovator. By representing IP as NFTs, it can be licensed, sold and commercialized. Organizations can also more easily view the IP as an asset on their balance sheet. Such use of NFTs will also help create completely new ways to interact with IP. For SMEs it allows IP to be treated as collateral, allowing it to be more easily leveraged when seeking funding. It will usher in new offerings by financial services firms and corporations to promote the evolution of a new patent asset class. Other benefits involve decreasing transaction costs and time, reducing ownership record-related risks or increased traceability. For instance, the access times, session durations, IP addresses per user and the terms of the NDA between Innovate.io and all parties to the Innovation are recorded on-chain, creating a trail of evidence.

The NFTs 2300 will be stored, secured and traced on a chain of custody solution (CoC Solution) on the Casper public blockchain. Innovate.io will also leverage the world's first Global Patent Registry (GPR) launched by IPWe in 2018 on Hyperledger. IBM and IPwe have worked together for the last three years applying IBM's deep expertise in blockchain and artificial intelligence to help protect ownership information.

Within the Innovate.io context, NFTs 2300, and with them IP rights, can be generated as soon as an Innovator wants to share an Initial Description of an innovation, independently of its score. In practice, the latter description is minted into an NFT containing a pointer to an IPFS URL where the encrypted Initial Description is stored. This NFT will be used as a reference point for smart contracts 2302 that organize the relationships between the Innovator and others, as exemplified in FIG. 23.

As shown in FIG. 23, If an Innovator has not shared the Initial Description with others and has passed the innovation threshold, the innovation is tokenized, i.e., stored in an NFT 2300, which is used as a reference object for the $Innovate tokens awarded to the Innovator. If and when the Innovator pursues intellectual property protection, that NFT is also used as a reference object for future use of services.

The Innovate.io NFT serves three critical functions: Information: all information related to the innovation is stored on the NFT. The date of conception, any documentation evidencing conception, filing history and the like are all stored in one accessible location. Ratings and Research: over time, an innovation will attract additional attention and the Innovate.io platform and other third parties will provide innovation ratings and research relating to the innovation. All of this will be easily searchable. Valuation and Transaction History and Prospects: ultimately the body of information available on the NFT enables valuation information which can be used to guide licensing or commercialization negotiations.

In the case that an Innovator decides to publish the innovation instead of pursuing protection, the contents of the data room are summarized and published after double confirmation by the Innovator in a publicly accessible online repository called the Innovate.io Library.

Such a library has the potential to become one of mankind's most valuable sources of creativity and open-access innovation to tackle challenges like overpopulation, world hunger, and climate change. The library starts with a compendium of the world's past and current patents (over ______ of data) and selected other resources (primarily dissertations and other relevant technical resources) and will grow and be indexed to assist innovators without tracking, advertising or other nefarious risks to innovators that exist in other search tools.

The Innovate.io Platform uses a range of tools to evaluate, refine and rate the Initial Description and subsequent iterations. The rating score relies on a validated rating methodology developed by IPwe, leveraging machine learning tools in development since 2007 and that have been used by the former owners to generate licensing revenues of over $500 million and raise financing in excess of $2 billion. Ultimately these AI tools will become open source so members of the Innovate.io platform can improve and build on them.

In harmony with the industry practice of transacting simple families rather than individual patent filings, IPwe algorithms use patent families as the most granular level of assessment for its ratings. A patent family is “a set of patents taken in various countries to protect a single invention”. Based on the harmonized view of WIPO, EPO, USPTO and CNIPA, a simple patent family is “the same invention [disclosed by common inventor(s) and] patented in more than one country.” Accordingly, an invention can be protected in more than one territory on the world's surface; the respective filings are linked structurally on the simple family level.

Using the Global Industry Classification Standard used in the financial rating industry, the classification algorithm identifies one of 32 Industries, or patented technology areas. Only stacks of patents belonging to the same technology area are compared with each other. Conceptually, IPwe rates patent families that feature at least one granted patent in one of the top 5 patent jurisdictions (being US, CN, EP, JP and KR).

Each invention has a total of 13 attributes structurally relevant for the rating. The attributes cover questions like validity prospects of the family, citations of the family, territorial span in meaningful jurisdictions for monetization, global filing trendlines, verification of title, and to some extent license and litigation records (if publicly available). The rating algorithm summarizes these attributes to an overall rating as the weighted average of the 13 rating attributes, normalized to make the ratings comparable.

Innovators leverage these algorithms to refine their Initial Descriptions following advice provided by the rating engine directly or seeking help from service providers. Service providers also use these algorithms, not only cutting their costs and hence the costs they pass on to Innovators but providing them with new information and analytics that can support the emergence of completely new innovation services.

The Innovate.io web platform is a menu-driven web platform with a simple user interface that leads stakeholders through the innovation process with explanatory video tutorials and detailed FAQs, providing individualized advice. Leveraging industry standard identity and access management and zero-trust features, the platform will provide Innovators full control as to who can access information about their innovation.

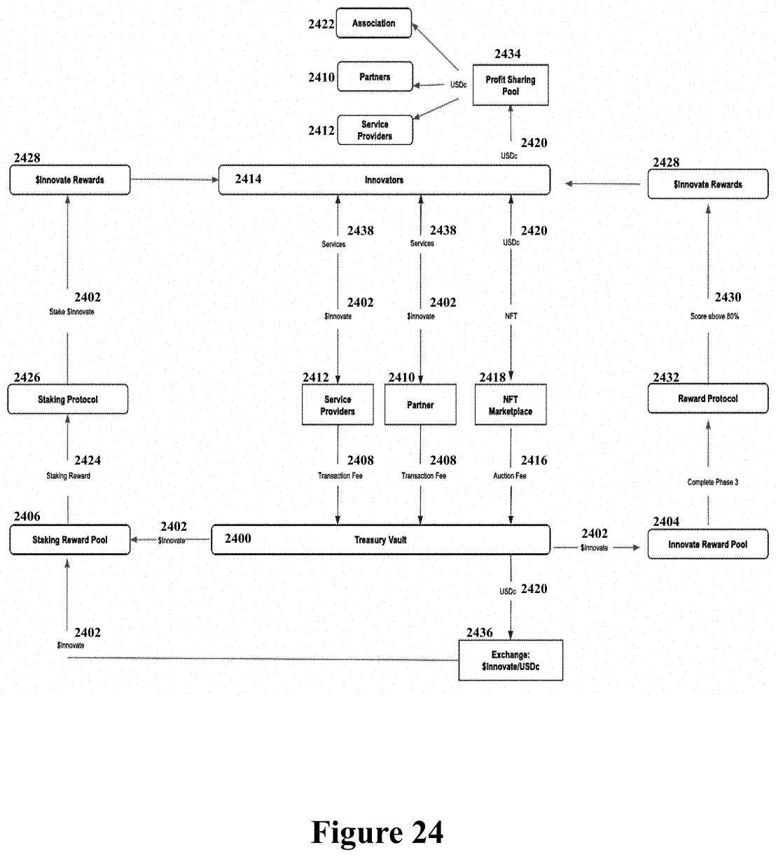

FIG. 24 is a flow diagram of the tokenomics design of the present invention. In accordance with the preferred embodiment of the present invention, the decentralized finance (DeFi) architecture of the present invention can be summed up in several key attributes. The Treasury Vault 2400 is used to control buying pressure and to channels tokens 2402 towards the Innovate Reward Pool 2404 and the Staking Reward Pool 2406. The Treasury Vault 2400 receives $innovate tokens 2402 or USD Coin (USDc) 2420 through transaction fees 2408 collected from partners (including investors) 2410, service providers 2412 and innovators 2414 and through trading fees 2416 on the NFT marketplace 2418. An automated and parametric system then facilitates the purchase of $Innovate tokens 2402 on the open market to replenish the tokens held by the Staking 2406 or Innovator Reward Pools 2404. While the Association 2422 will control the Treasury 2400 at start, the system is built in a way that enables a future transition to a fully decentralized economy. The Association 2422 creates the structure and once in place, the control of token rewards will move directly into the hands of token stakers.

The Staking Reward Pool 2406 accumulates $innovate tokens 2402 from the Treasury Vault 2400 which are then distributed among stakers 2424 using the Staking Protocol 2426. $innovate token holders visualize their stake and anticipate rewards 2428 dynamically.

The Innovators Reward Pool 2404 contains tokens 2402 used to reward Innovators whose innovations have scored above the threshold 2430. Like the Treasury Vault 2400 and Staking Reward Pool 2406, tokens in this pool are assigned by the monetary policy 2432. It is worth noting that tokens awarded to Innovators from this reward pool 2404 cannot be exchanged against USDc 2420 to avoid ill-intended users inputting false innovation ideas to sell tokens for profit. The tokens awarded to innovators can only be used to protect, enhance, develop, finance and commercialize their innovation through the Innovate.io Platform.

The Profit-Sharing Pool 2434 allows for Innovators 2414 to retribute Service Providers 2412, Partners 2410 (including financial and expert partners) and/or the Association 2422 in USDc 2420 instead of $Innovate tokens 2402, once the innovation starts to generate an economic return. The agreements allocating such profits are hardcoded in smart contracts, linked to each innovation NFT, and could account for any type of allocation mechanisms, from lump sums to split ownership of the innovation.

The Exchange 2436 is used to channel all USDc 2420 accumulated in the Treasury Vault 2400 to the two Reward Pools. However, since the pools only distribute rewards in $Innovate 2402 tokens, USDc 2420 needs to be first exchanged for $Innovate tokens 2402. This process will ensure a consistent buying pressure of the $Innovate token 2402 and is considered as one of the main drivers of the token's stability.

Inflow Channels stem from fee-based economic transactions that provide value to the community. The inflow of fees gets channeled to the Treasury Vault and eventually gets distributed to stakers and innovators in the system as a reward for contributing to the network. Transaction Fee 2408 accumulated from transaction volume occurred among innovators 2414 and service providers 2412 and partners 2410. The platform charges 5% service fee 2438 in $Innovate tokens 2402. Marketplace fee received from trading operations across the NFT Marketplace. The platform takes 2.5% from each trade in USDc. The main portion of selling price stays with innovators who own NFTs. Although due to special arrangements with Service Providers and Partners they can launch a revenue-sharing pool. The pool splits NFT selling prices among stakeholders upon agreed terms.

Outflow Channels originate from the Innovators or Staking Reward Pools 2406 and are distributed to the community through the pools' respective protocols. The innovators can receive these rewards by either reaching the score above threshold for their innovation or holders of $innovate tokens 2402 can receive the rewards by staking the $Innovate tokens 2402. The Innovators rewards and Staking Protocols control the reward outflow in a way that maintains a balanced economy and ensures enough incentive for particular groups of activities. 60% of the Treasury Vault 2400 proceeds to the Innovators Reward Pool for distribution to Innovators. Treasury Vault sends 25% of its inflows to the Staking Reward Pool to incentivize token holding patterns and reduce token selling pressure within exchanges. The Association receives 15% from the Treasury Vault for multi-purposed reserves.

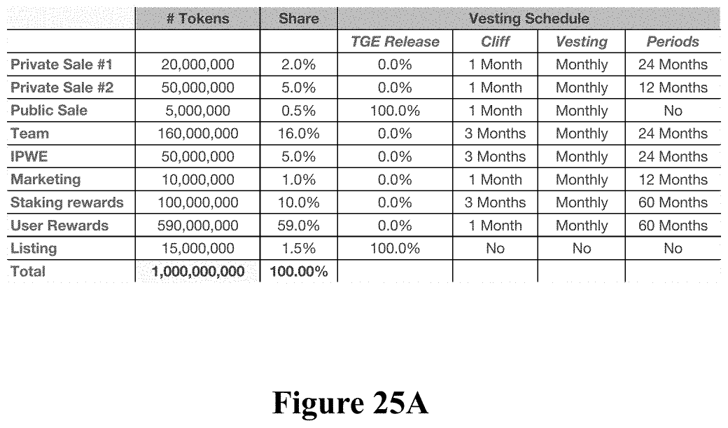

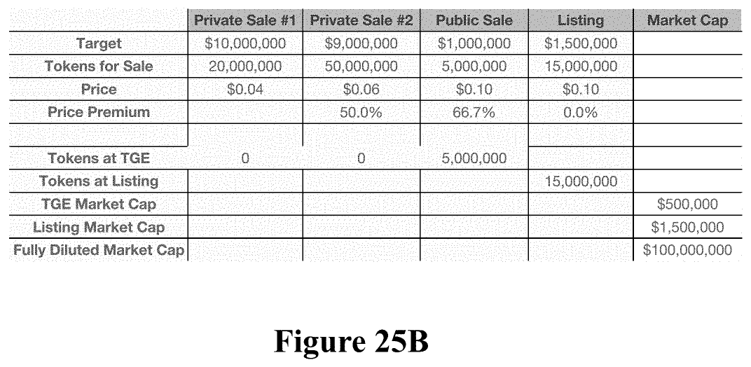

FIGS. 25A-B are images of token distribution and sale details of the present invention. In accordance with the preferred embodiment of the present invention, FIG. 25A is an image showing an example of token distribution details of the present invention. FIG. 25B is an image showing example token sale details of the present invention.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of”

What is claimed is:

1. A method for establishing ownership of intellectual property assets, the method comprising: using a decentralized database to combine historical transaction data corresponding to a plurality of transactions relating to intellectual property;
deploying a smart contract to pool data related to specific IP transactions;
normalizing the remuneration structure of specific transactions in order to extract normalized values thereof and storing said values in a second, market value database;
dissecting and analyzing the transaction data according to a predetermined scheme;
evaluating the importance of selected determinants according to predetermined criteria to obtain ratings and weightings corresponding thereto;
compiling an artificial neural network knowledgebase, deployable on a blockchain, using information related the ratings and weightings;
extracting financial and market data from the transaction data;
updating the artificial neural network knowledgebase with current transaction data, current market value data, and current financial and market data relating to a transaction under consideration, according to predetermined criteria, to identify similarities between the stored data and the said current data, thereby to generate an initial valuation model for the transaction under consideration;
recording ownership of non-fungible tokens associated with said intellectual property assets by use of said decentralized database; and
applying weightings, priorities and/or probabilistic criteria to the valuation model according to criteria related to the transaction under consideration to generate a final valuation model.

2. The method of claim 1, further comprising extracting conceptual data from the transaction data and storing the extracted conceptual data in the blockchain network.

3. A distributed network for valuing intellectual property assets, the network comprising:
a distributed network, the network comprising:
a plurality of nodes, wherein each node in the plurality of nodes is configured to transact autonomously with at least two nodes in the plurality of nodes and configured to communicate with at least one server;
the server comprising at least one hardware processor, a non-transitory machine-readable storage medium having an executable computer readable program code, the hardware processor configured to execute the computer-readable program code;
the server, capable of identifying at least one user using a private key and a public key and connected to an at least one user device;
the user device capable of communicating with the plurality of nodes;
the computer readable program code, configured to categorize an intellectual property asset and pass historical information related to the intellectual property asset to a neural network;
the neural network capable of deploying an algorithm, the algorithm used for analyzing the historical data based on a number of pre-defined categories;
the neural network further capable of outputting a valuation related to the IP asset to determine a value for the IP asset;
the decentralized database activated for recording ownership of non-fungible tokens associated with said intellectual property assets; and
the neural network capable of passing the value related to the IP asset to the distributed network.

4. The distributed network of claim 3, wherein the network is a blockchain network.

5. The distributed network of claim 3, wherein the computer readable code is a smart contract.

6. The distributed network of claim 3, wherein the decentralized network is further capable of conducting transactions using FIAT currency.

7. The distributed network of claim 3, wherein the decentralized network is further capable of conducting transactions using cryptocurrency.

8. The neural network of claim 3, wherein the algorithm used to analyze the patent value is updated each time it is run.

9. The neural network of claim 3, wherein a third party may input additional information to update the algorithm.

10. A public ledger network comprising:
At least one hardware processor, a non-transitory machine-readable storage medium having an executable computer readable program code, the at least one hardware processor configured to execute the computer-readable program code to:
receiving, by the secure ledger network, a request to evaluate an intellectual property asset;
categorizing the intellectual property asset;
obtaining information from available public and private sources related to the intellectual property asset;
passing information related to the intellectual property asset to a neural network;
the neural network configured to deploy an algorithm used to determine the value of the intellectual property asset;
the value of the intellectual property asset further passed to the public ledger network;
the ledger updated with the value of the intellectual property asset;
the public ledger network further configured to deploy a smart contract;
the smart contract containing at least one rule related to the exchange of currency for an agreement to license or purchase the intellectual property asset;
the decentralized database activated for recording ownership of non-fungible tokens associated with said intellectual property assets; and
when executed, the smart contract configured to transfer currency as determined by the rule.

11. The public ledger network of claim 10, wherein the network is a blockchain network.

12. The public ledger network of claim 10, further capable determining the owner of the intellectual property asset.

13. The public ledger network of claim 10, wherein the owner of the intellectual property asset can request its value.

14. The public ledger network of claim 10, wherein a third party can request the value of any intellectual property asset.

15. The public ledger network of claim 10, wherein the currency is cryptocurrency.

16. The public ledger network of claim 10, wherein the currency is FIAT currency.

17. The public ledger network of claim 10, further configured to pass data related to the IP asset to the neural network, the neural network further capable of updating the algorithm based on the data.
